(19) United States
(12) Patent Application Publication
(10) Pub. No.: US 2015/0232293 A1
(43) Pub. Date: Aug. 20, 2015

(54) SHEET CONVEYING APPARATUS AND IMAGE FORMING APPARATUS

(71) Applicant: CANON KABUSHIKI KAISHA, Tokyo (JP)

(72) Inventors: Kenjiro Sugaya, Moriya-shi (JP); Koji Takematsu, Abiko-shi (JP); Kazuhisa Okuda, Tokyo (JP); Shutaro Saito, Kashiwa-shi (JP)

(21) Appl. No.: 14/606,231

(22) Filed: Jan. 27, 2015

(30) Foreign Application Priority Data
Feb. 19, 2014 (JP) 2014-029213
Apr. 30, 2014 (JP) 2014-093703
Dec. 26, 2014 (JP) 2014-263790

(51) Int. Cl. G03G 15/20; B65H 59/00; B65H 5/22

(52) U.S. Cl. CPC B65H 5/068; B65H 5/36; B65H 7/20; G03G 15/2028

(57) ABSTRACT

Provided is a sheet conveying apparatus which includes a conveyance unit and a controller. The conveyance unit includes a first pair of rotators which convey a sheet, a second pair of rotators which are provided on a downstream side of the first pair of rotators in a sheet conveying direction and convey the sheet, and a load portion which applies a load on the rotation of the first pair of rotators to generate a tensile stress on the sheet when the sheet is nipped between the first pair of rotators and the second pair of rotators. The controller controls whether to apply a load on the first pair of rotators by the load portion based on information on the conveyed sheet.

### BACKGROUND OF THE INVENTION

1. Field of the Invention

The present invention relates to a sheet conveying apparatus employed in an image forming apparatus such as a copying machine, a printer, and a facsimile machine in which an unfixed toner image is heated and pressed to be fixed, and an image forming apparatus such as a printer and a facsimile machine which includes the sheet conveying apparatus.

2. Description of the Related Art

Conventionally, an image forming apparatus employing an electrophotographic system develops and visualizes a latent image formed on a photosensitive drum serving as an image bearing member, and transfers the visualized image (toner image) onto a sheet using an electrostatic force. Next, the toner image on the sheet is heated and fixed, so that an image is recorded on the sheet.

In a fixing apparatus of the image forming apparatus, there is employed a heat roller fixation system in which an elastic pressure roller comes in press contact with a fixing roller which includes a heat source such as a heater therein for keeping its temperature at a predetermined temperature so as to form a fixing nip portion, and the toner image is fixed on the sheet by the fixing nip portion.

In recent years, as such type of fixing apparatus which is used in the image forming apparatus (in particular, a full-color image forming apparatus), there is known a fixing apparatus which can make a heating time long and a fixing speed high from a viewpoint of improving a coloring property or an image quality of the toner image. For example, as disclosed in Japanese Patent Laid-Open No. 5-150679, there is known a so-called belt nip system of fixing apparatus in which an endless fixing belt is suspended on a plurality of rollers and comes in press contact with a heating roller.

In addition, in recent years, a process speed is also necessarily increased in order to make the output of the image forming apparatus increased in speed. Therefore, a wider nip width is required in a width direction perpendicular to a sheet conveying direction, and thus a belt fixing system in which the fixing roller, the pressure roller, or both rollers are replaced with an endless belt to secure a wide nip width is proposed and commercialized.

However, in such a fixing apparatus, heat and pressure are applied to the sheet on which the toner image is transferred in a heat-fixing process. Therefore, moisture is evaporated from the inside of the sheet in the nip portion and after passing through the nip portion. At this time, a variation in moisture amount due to the heat applied to the sheet and a stress applied on the sheet by the pressure causes a phenomenon called curling that the sheet is bent or a phenomenon called rippling that the sheet undulates in its shape.

Herein, a sheet-like paper most generally used as the sheet will be taken a look at a fiber level. The paper is composed of short fibers tangled with each other, and moisture is contained in the fibers or between the fibers. Furthermore, since the fibers and the moisture enter an equilibrium state when hydrogen bonding occurs, the paper has smoothness.

However, when heat and pressure is applied to the paper in the fixing process, a displacement occurs between the fibers due to the pressure. When the heat is applied in this state to cause the moisture to evaporate, the hydrogen bonding further occurs in the fibers to cause deformation. When being left as it is, the paper is wet under the environment, and the hydrogen bonding of the fibers is disconnected again and returns to the original state. However, the moisture does not go between some fibers in the paper, and thus the deformation of the paper is maintained. The deformation pattern includes the curling and the rippling described above. The curling is generated by a difference in expansion and contraction of the front and rear surface of the paper, and the rippling is generated by a difference in expansion and contraction in the center portion and the end portion of the paper.

A first cause of generating the rippling in the end portion of the sheet occurs when the sheet is in process of passing through the nip portion of the fixing apparatus. For example, in the case of the fixing apparatus provided with the wide nip portion in such a belt fixing system, a conveyance speed of the end portion is set to be higher than the center portion in the width direction perpendicular to the sheet conveying direction in the nip portion in order to prevent wrinkles from being generated when the sheet passes through the nip portion. Therefore, in a case where a pulsing action is applied to the sheet, the end portion of the sheet is extended in the conveyance direction further more compared to the center portion after passing through the nip portion, so that the rippling is generated in the end portion of the sheet.

A second cause of generating the rippling in the end portion of the sheet occurs after the sheet passes through the nip portion of the fixing apparatus. In a state where the sheets are stacked up together as a sheet bundle, the end portions of the respective sheets come into contact with the air, so that moisture goes in and out frequently. When the sheet is added with the heat in the fixing process to cause the moisture to evaporate from the inside of the sheet and then the end portion is rapidly wet, the end portion of the sheet is extended in the conveyance direction further more compared to the center portion. Therefore, the rippling is generated in the end portion of the sheet.

In particular, in the belt fixing system in which the nip width is secured wide by replacing the fixing roller, the pressure roller, or both of them with the endless belt, a distance or time taken when the sheet stays in the nip portion is increased compared to the thermal roller system. Therefore, the rippling problem is easily remarkable in the end portion of the sheet.

Regarding a length of the sheet conveying direction, in order to solve the problem that the end portion in the width direction perpendicular to the sheet conveying direction is extended further more compared to the center portion, it is considered a countermeasure in which a tension (tensile force) in the conveyance direction is applied to the center portion of the sheet to correct the lengths in the conveyance direction of the center portion and the end portion of the sheet. The tension (tensile force) is applied in the conveyance direction with respect to the sheet, but there is a need to set the tension not to cause damage on the sheet.

### SUMMARY OF THE INVENTION

It is desirable to improve rippling of a sheet while suppressing stress on the sheet at a minimum level.

In order to achieve the above object, there is provided a sheet conveying apparatus according to the invention, the sheet conveying apparatus includes as follows: a conveyance unit configured to include a first pair of rotators which convey a sheet, a second pair of rotators which are provided on a downstream side of the first pair of rotators in a sheet conveying direction and convey the sheet, and a load portion which applies a load on the rotation of the first pair of rotators to generate a tensile stress on the sheet when the sheet is nipped between the first pair of rotators and the second pair of rotators; and a controller configured to control whether to apply a load on the first pair of rotators by the load portion based on information on the conveyed sheet.

According to the invention, it is possible to improve rippling of a sheet while suppressing stress on the sheet at a minimum level.

Further features of the present invention will become apparent from the following description of exemplary embodiments with reference to the attached drawings.

### BRIEF DESCRIPTION OF THE DRAWINGS

FIG. 1 is a cross-sectional view illustrating a pulling and conveying apparatus of a first embodiment.

FIG. 2 is a cross-sectional view illustrating an electrophotographic printer of the first embodiment.

FIG. 3 is a block diagram illustrating a control relation of the electrophotographic printer and an entire sheet rippling correction apparatus.

FIG. 4 is a cross-sectional view illustrating a humidification apparatus of the first embodiment.

FIG. 5 is a perspective view illustrating the vicinity of a reservoir of the humidification apparatus of the first embodiment.

FIG. 6 is a perspective view illustrating the pulling and conveying apparatus of the first embodiment.

FIG. 7 is a top view illustrating the pulling and conveying apparatus of the first embodiment.

FIG. 8 is a perspective view illustrating the driving of the pulling and conveying apparatus of the first embodiment.

FIGS. 9A and 9B are flowcharts illustrating a control of the pulling and conveying apparatus of the first embodiment.

FIG. 10 is a cross-sectional view illustrating a control operation of the pulling and conveying apparatus of the first embodiment.

FIG. 11 is a cross-sectional view illustrating the control operation of the pulling and conveying apparatus of the first embodiment.

FIG. 12 is a cross-sectional view illustrating the control operation of the pulling and conveying apparatus of the first embodiment.

FIG. 13 is a cross-sectional view illustrating the control operation of the pulling and conveying apparatus of the first embodiment.

FIG. 14 is a diagram for describing a state of a sheet and a method of measuring the sheet.

FIGS. 15A and 15B are graphs illustrating results obtained through an experiment on the state of the sheet.

FIGS. 16A and 16B are graphs illustrating results obtained through an experiment on the state of the sheet.

FIGS. 17A and 17B are graphs illustrating results obtained through an experiment on the state of the sheet.

FIG. 18 is a cross-sectional view illustrating an electrophotographic printer of a second embodiment.

FIG. 19 is a cross-sectional view illustrating a pulling and conveying apparatus of the second embodiment.

FIG. 20 is a perspective view illustrating a pulling and conveying apparatus according to a modification of the second embodiment.

FIG. 21 is a cross-sectional view illustrating the pulling and conveying apparatus according to a modification of the second embodiment.

FIG. 22 is a cross-sectional view illustrating a pulling and conveying apparatus according to a modification of a third embodiment.

### DESCRIPTION OF THE EMBODIMENTS

Hereinafter, exemplary embodiments of the invention will be described in detail with reference to the drawings. However, dimensions, materials, shapes, relative arrangement of components described in the following embodiments may be suitably changed depending on a configuration or various conditions of the apparatus of the invention. Therefore, if not otherwise specified, there is no purpose of limiting the scope of the invention only to these embodiments.

### First Embodiment

### Configuration of Entire Apparatus

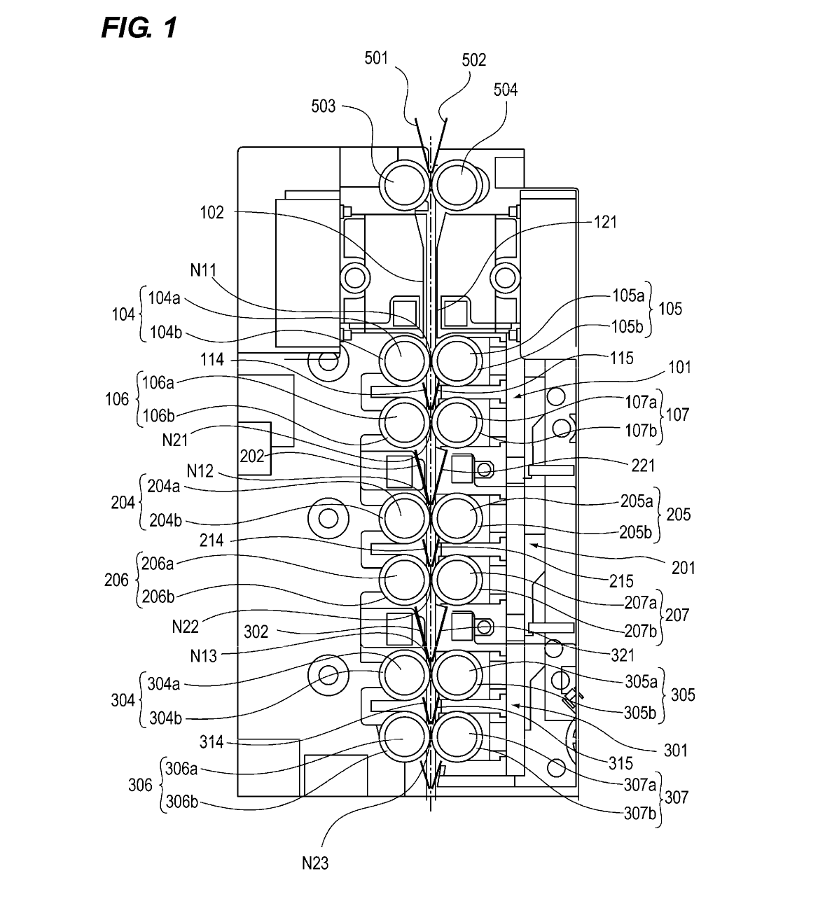

An image forming apparatus which includes a sheet conveying apparatus relating to a first embodiment will be described using FIGS. 1 to 7. In the following description, the image forming apparatus will be first described, and then the sheet conveying apparatus will be described. In the embodiment, the description will be made about an image forming system in which the sheet conveying apparatus is connected outside the image forming apparatus. However, the invention is also effectively applied to a configuration of the image forming system in which the sheet conveying apparatus is integrally assembled in the image forming apparatus.

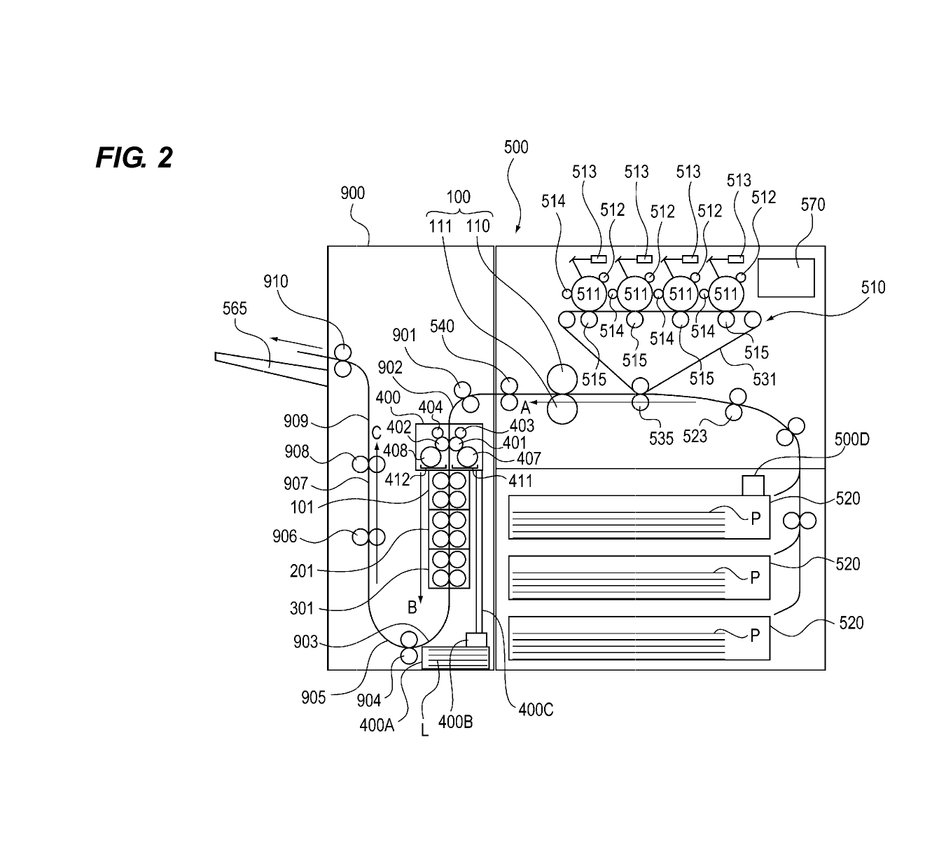

First, the description will be made using FIG. 2 about an image forming apparatus as an example of the image forming system and a sheet conveying apparatus which is detachably connected to the image forming apparatus. FIG. 2 is a cross-sectional view schematically illustrating a sheet rippling correction apparatus 900 which includes a color electrophotographic printer 500 as an example of the image forming apparatus and a tension applying apparatus as an example of the sheet conveying apparatus, which is a cross-sectional view taken along a conveying direction of the sheet. Further, in the following description, the color electrophotographic printer will be simply referred to as a “printer”.

The sheet is used to form a toner image thereon. Specific examples of the sheet include a plain paper, a resin sheet-like medium as a substitute of the plain paper, a cardboard, a sheet for an overhead projector, and the like.

The printer 500 illustrated in FIG. 2 includes image forming portions 510 of the respective colors Y (yellow), M (magenta), C (cyan), and Bk (black). The image forming portions 510 of the respective colors serve to form toner images of the respective colors in the sheet. Then, an endless intermediate transfer belt 531 as an intermediate transfer member is disposed to face the image forming portions. In other words, the image forming apparatus employs a tandem system in which processes until an image is visualized are performed in parallel for each color.

Further, an arrangement order of the image forming portions of the respective colors Y, M, C, and K is not limited to the arrangement order illustrated in FIG. 2. In addition, the image forming apparatus is not limited to the full color intermediate transfer system illustrated in FIG. 2, and is possible to be applied to a monochrome image forming apparatus.

In the image forming portion 510 of each color, the following processing portions are provided. There are provided an electrophotographic photosensitive member (hereinafter, referred to as a photosensitive drum) 511 as an image bearing member which bears an electrostatic latent image in the surface corresponding to each color of Y, M, C, and K, a charging roller 512, a laser scanner 513, and a development device 514. The photosensitive drum 511 is charged by the charging roller 512 in advance. Then, the photosensitive drum 511 is exposed to light from the laser scanner 513 and a latent image is formed. The latent image is developed by the development device 514 to be visualized as the toner image.

In a primary transfer portion between the photosensitive drum 511 and a primary transfer roller 515, the respective toner images formed and borne in the surfaces of the photosensitive drums 511 are primarily transferred onto the intermediate transfer belt 531 by the primary transfer roller 515 in a sequentially superimposed manner.

On the other hand, the sheet P is fed out of a sheet cassette 520 one by one and fed into a pair of registration rollers 523. The pair of registration rollers 523 once stop the sheet P, and correct skew feeding of the sheet when the sheet is fed on the skew. Then, the pair of registration rollers 523 feed the sheet P into a secondary transfer portion between the intermediate transfer belt 531 and a secondary transfer roller 535 in synchronization with the toner image on the intermediate transfer belt 531. The color toner images on the intermediate transfer belt 531 are secondarily transferred onto the sheet P in a collective manner, for example, using the secondary transfer roller 535 which is a transfer portion.

Then, as described above, the sheet on which the image (the toner image) is formed by the image forming portion is conveyed to a fixing apparatus 100. In the fixing apparatus (a fixing portion) 100, the sheet is nipped in a fixing nip portion, and heat and pressure are applied to an unfixed toner image. Therefore, the toner image is fixed on the sheet. The sheet passing through the fixing apparatus 100 is sent to the sheet rippling correction apparatus 900 serving as a sheet processing apparatus which processes the sheet using a pair of discharge rollers 540. After the rippling of the sheet is corrected by the sheet rippling correction apparatus 900, the sheet is discharged to a discharge tray 565.

Herein, the fixing apparatus will be described. The fixing apparatus 100 includes a fixing roller 110 serving as a heating rotator and a pressure roller 111 serving as a pressure rotator. The fixing roller 110 applies heat generated by a halogen lamp (not illustrated) therein to the toner on the sheet P and conveys the sheet P in corporation with the pressure roller 111. The fixing roller 110, for example, is configured to include the halogen lamp in a metal core formed of an aluminum cylinder pipe (having an external diameter of 56 mm and an internal diameter of 50 mm). In the surface of the metal core, for example, an elastic layer formed of a silicon rubber (having a thickness of 2 mm and a hardness (ASKER C) of) 45° is further coated by a PFA or PTFE heat resistant toner parting layer on the surface of the elastic layer.

The pressure roller 111 conveys the sheet P in cooperation with the fixing roller 110. The pressure roller 111, for example, also has a metal core formed of an aluminum cylindrical pipe (having an external diameter of 56 mm and an internal diameter of 50 mm). In the surface of the metal core, for example, an elastic layer formed of a silicon rubber (having a thickness of 2 mm and a hardness (ASKER C) of 45°) is further coated by a PFA or PTFE heat resistant toner parting layer on the surface of the elastic layer.

The fixing nip portion is formed by the fixing roller 110 and the pressure roller 111. The inventors performed an experiment in which the sheet P was conveyed at a conveyance speed of about 300 to 500 mm/sec under conditions that a setting temperature of the surface layer of the fixing roller 110 was 180° C., a setting temperature of the surface layer of the pressure roller 111 was 100° C., an environmental temperature was 23° C., and an environmental humidity was 50%. In this experiment, the sheet P was heated and pressed in the fixing nip portion, and the fiber on end portion sides in a width direction perpendicular to a sheet conveying direction was extended in the conveyance direction compared to the center portion, and as a result end rippling (hereinafter, referred to as rippling) was generated on end portions.

The sheet P on which the toner image is fixed by the fixing apparatus 100 is sent to the sheet rippling correction apparatus 900 by the pair of discharge rollers 540. The sheet P is conveyed along a conveyance guide 902 by a pair of inlet rollers 901 of the sheet rippling correction apparatus 900. Then, the sheet P is turned its conveyance direction to a vertical direction by the conveyance guide 902, and sequentially sent to a humidification apparatus 400 serving as a humidification portion and sheet pulling and conveying apparatuses 101, 201, and 301 serving as a conveyance unit. The humidification apparatus 400 humidifies and conveys the sheet P in order to compensate moisture of the sheet P which has been dehydrated by the heat of the fixing apparatus 100, and to relax the fiber of the sheet P. The sheet P passed through the humidification apparatus 400 sequentially passes through the sheet pulling and conveying apparatuses 101, 201, and 301, and the center portion in the width direction perpendicular to the sheet conveying direction is extended in the conveyance direction. Therefore, a difference of length in the sheet conveying direction between the end portion and the center portion in the width direction is reduced.

In this way, the sheet P of which the rippling of the end portion in the width direction of the sheet is improved is turned its conveyance direction vertically upward by conveyance guides 903 and 905, and is conveyed by a pair of conveying rollers 904. Then, the sheet P is conveyed by a pair of conveying rollers 906 and 908 while being guided by conveyance guides 907 and 909, discharged to the outside of the sheet rippling correction apparatus 900 by a pair of discharge rollers 910, and stacked on the discharge tray 565.

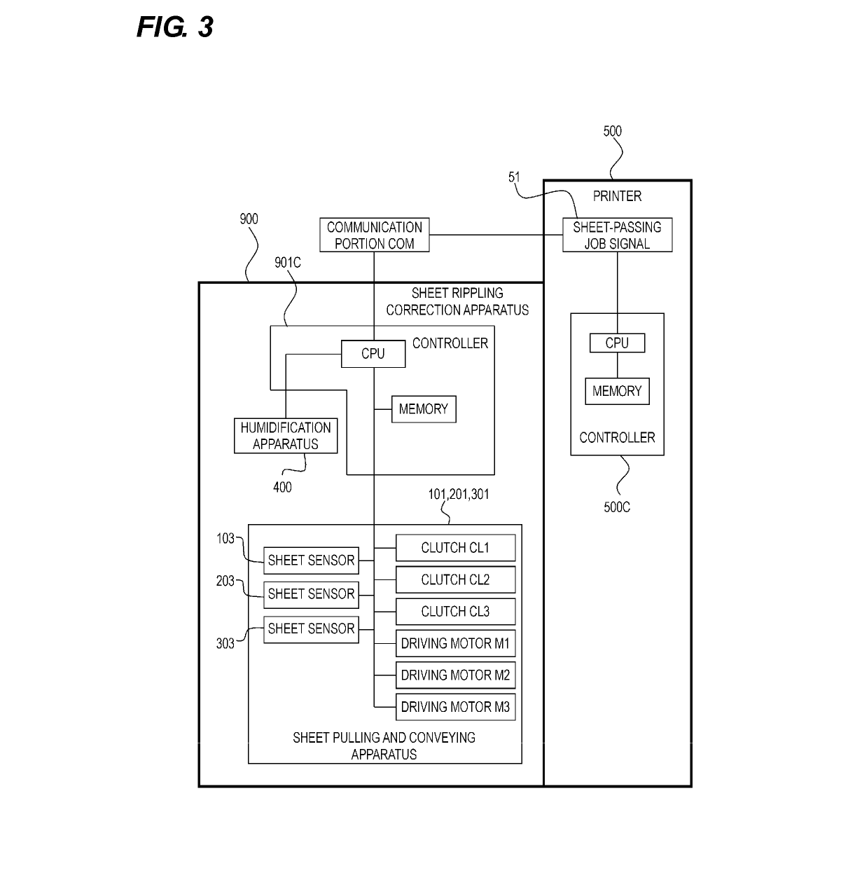

Herein, a control relation of the entire image forming system will be described using FIG. 3. FIG. 3 is a block diagram illustrating the control relation between the printer 500 and the entire sheet rippling correction apparatus 900 which comprise the image forming system. A controller 500C of the printer 500 and a controller 901C of the sheet rippling correction apparatus 900 are a computer system which includes a CPU, a memory, a calculation unit, an I/O port, a communication interface, a driving circuit, and the like.

The control performed by each of the controllers 500C and 901C is performed by executing a predetermined program stored in the memory by each CPU. The controller 901C of the sheet rippling correction apparatus 900 controls the operations of the humidification apparatus 400 and the sheet pulling and conveying apparatuses 101, 201, and 301 which comprise the apparatus. In addition, the respective controllers 500C and 901C are connected through a communication portion COM, and can perform information exchange.

### <Description of Humidification Apparatus>

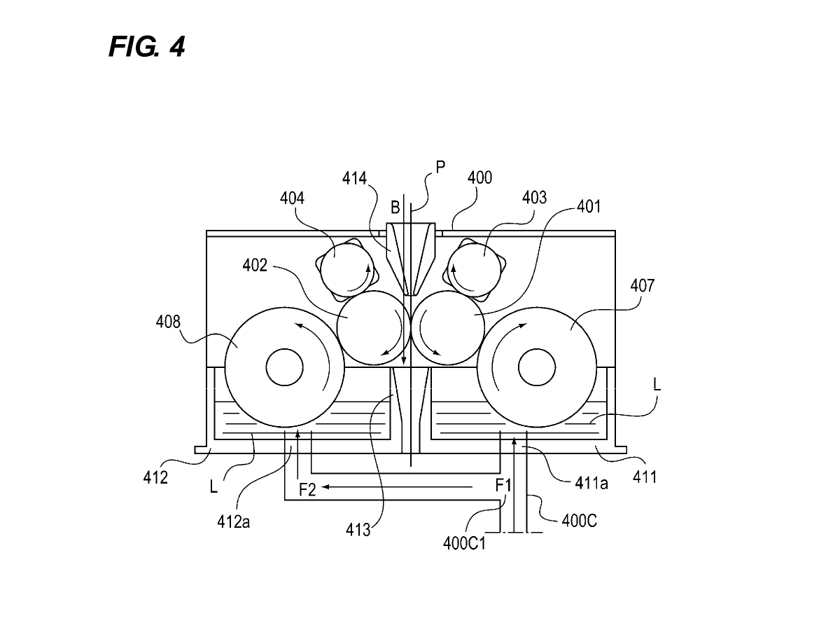

Hereinafter, the humidification apparatus 400 will be described using FIGS. 2, 4, and 5. FIG. 4 is a cross-sectional view of the humidification apparatus 400.

The sheet P sent in a direction of arrow B of FIG. 4 similarly to arrow B of FIG. 2 is guided to an inlet guide 414 and enters the nip portion of a pair of humidification rollers 401 and 402. Then, humidification liquid L is transferred onto the surfaces (both faces) of the sheet P by the pair of humidification rollers 401 and 402 to humidify the sheet P.

The pair of humidification rollers 401 and 402 are elastic rollers in which a solid rubber layer having NBR or silicon as a main component is formed on the surface of a shaft core made of a metal rigid body such as stainless steel.

Water feeding rollers 407 and 408 are water feeding members for sequentially supplying the humidification liquid L to humidifying rollers 401 and 402. The water feeding rollers 407 and 408 are elastic members in which material having a hydrophilic surface configured to hold the humidification liquid L in the surface of a shaft core made of a metal rigid body such as stainless steel; for example, the solid rubber layer having NBR as a main component is formed. The solid rubber layer may be formed using metal or resin subjected to hydrophilic treatment.

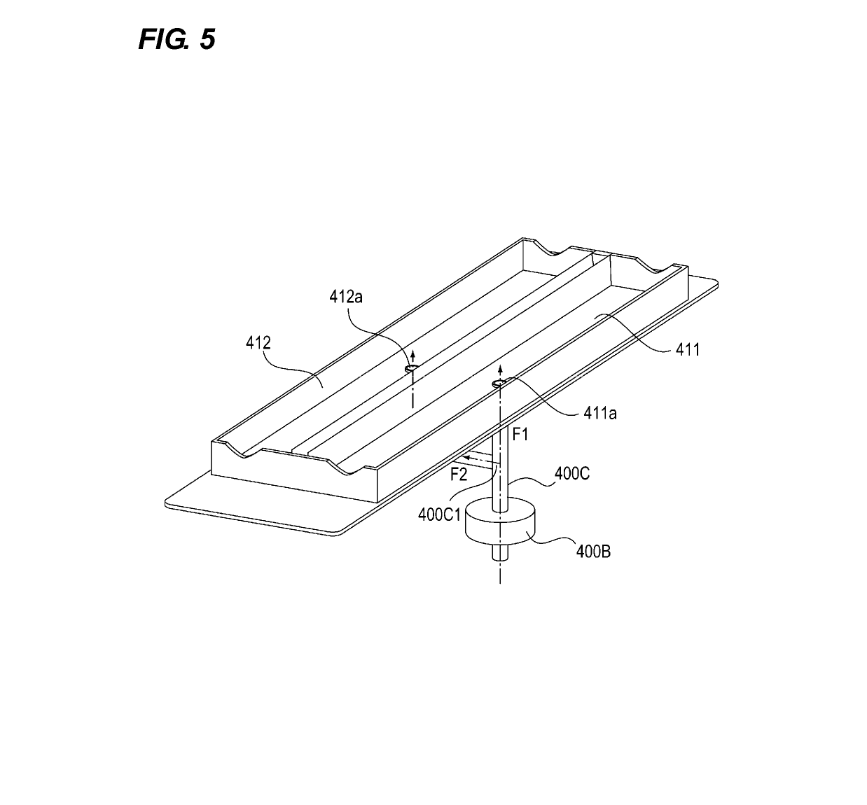

Supplying and discharging the humidification liquid L with respect to a water storage tank and the humidification apparatus will be described using FIGS. 4 and 5. FIG. 5 is a diagram for describing the vicinity of a reservoir.

A water storage tank 400A illustrated in FIG. 2 is a water storage tank which contains the humidification liquid L for humidifying the sheet P. The humidification liquid L contained in the water storage tank 400A is supplied toward a feed water tank (reservoir portion) 412 of the humidification apparatus 400 by a feed water pump 400B at any time. In the embodiment, the humidification liquid L is a liquid having water as a main component, and a surfactant is mixed therein in consideration of humidifying efficiency and permeability to the sheet P.

The water storage tank 400A is connected to the feed water tanks 411 and 412 provided in the humidification apparatus 400 through the feed water pump 400B. FIG. 4 illustrates the connection state.

The humidification liquid L contained in a feed water pipe 400C is supplied by the feed water pump 400B through a branch portion 400C1 provided in the feed water pipe 400C, and branched and fed toward the feed water tanks 411 and 412 in directions of arrows F1 and F2 illustrated in FIGS. 4 and 5. The pipes branched from the feed water pipe 400C are respectively connected to feed water holes 411a and 412b which are provided in the bottom portions (substantially directly-lower portions of the water feeding rollers 407 and 408) of the feed water tanks 411 and 412.

The bottom portions of the water feeding rollers 407 and 408 are soaked in the humidification liquid L which is supplied by the feed water pump 400B and collected in the bottom portion of the feed water tanks 411 and 412 through the feed water holes 411a and 412b. The water feeding rollers 407 and 408 rotate in directions of arrows illustrated in FIG. 4, and thus the humidification liquid L is supplied to the humidifying rollers 401 and 402. The humidification liquid L is pumped up by its own viscosity and surface tension or by the action of wettability of the rubber surface layers of the water feeding rollers 407 and 408.

The humidification liquid held on the surface layers of the water feeding rollers 407 and 408 is further transferred onto the surface layers of the humidifying rollers 401 and 402, and at the same time is squeezed from respective scraping rollers 403 and 404. Therefore, the humidification liquid L is transferred onto the surface layers of the respective humidifying rollers 401 and 402 while maintaining uniformity. The scraping rollers 403 and 404, for example, are formed by stainless steel or a material obtained through hard chromium plating on its steel surface.

The humidifying roller 401, the water feeding roller 408, and the scraping roller 404 are pressed (biased) to the humidifying roller 402 by a pressure spring (not illustrated). In addition, the water feeding roller 407 and the scraping roller 403 are pressured (biased) to the humidifying roller 401 by a pressure spring (not illustrated).

The sheet P passed through the humidification apparatus 400 is guided between guides 501 and 502 as illustrated in FIG. 1, conveyed to a pair of inlet rollers 503 and 504, and guided between inlet guides 102 and 121 in the sheet pulling and conveying apparatus 101.

### <Description of Pulling and Conveying Apparatus>

Next, each configuration of the sheet pulling and conveying apparatuses (101, 201, and 301) serving as a conveyance unit will be described using FIGS. 1, 6, and 7. In the embodiment, the first sheet pulling and conveying apparatus 101, the second sheet pulling and conveying apparatus 201, and the third sheet pulling and conveying apparatus 301 have the same configuration. Each of the first sheet pulling and conveying apparatus 101, the second sheet pulling and conveying apparatus 201, and the third sheet pulling and conveying apparatus 301 includes a plurality of pairs of rollers to apply a tensile force on the sheet to make the center portion of the sheet P in the width direction extended in the conveyance direction. Therefore, the components (symbols) are jointly used for the configuration of the sheet pulling and conveying apparatus to be described below.

Further, the conveyance speed by the pair of rollers (or roller) in the following description means a rotation speed (linear speed) of the pair of rollers (or roller).

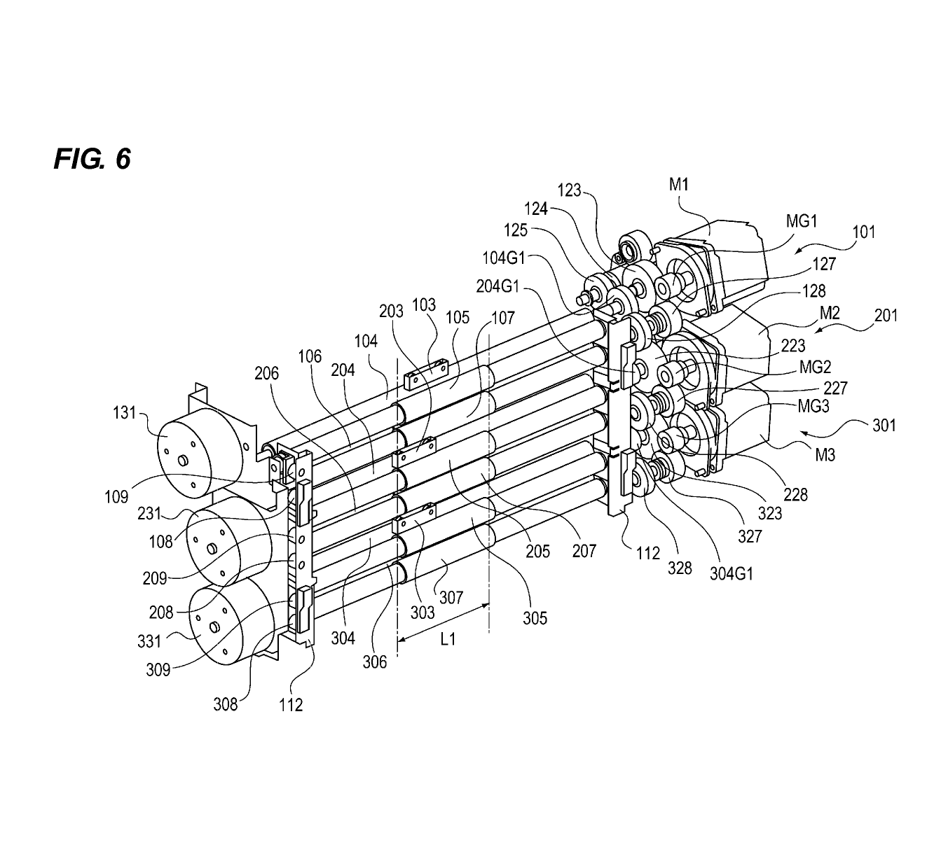

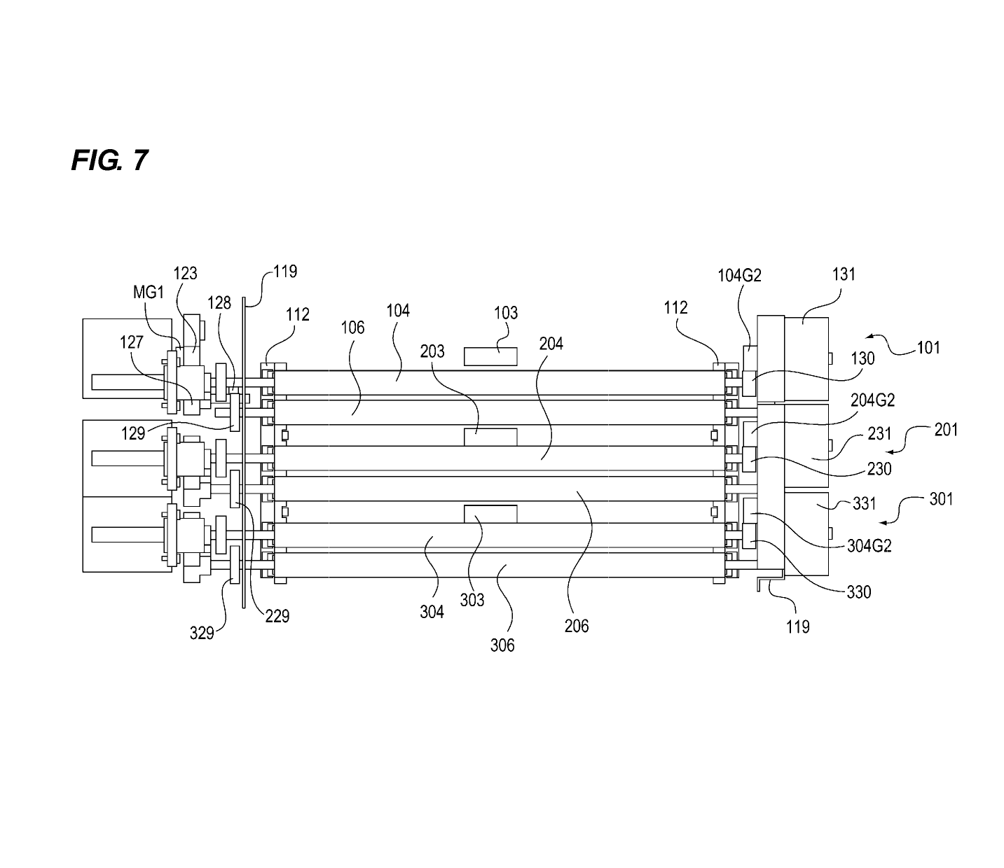

FIG. 1 is a cross-sectional view for describing the sheet pulling and conveying apparatuses 101, 201, and 301 of the embodiment when viewed from the front side. In addition, FIG. 6 is a perspective view for describing the sheet pulling and conveying apparatuses 101, 201, and 301 of the embodiment, and FIG. 7 is a left side view for describing the sheet pulling and conveying apparatuses 101, 201, and 301 of the embodiment.

Each sheet pulling and conveying apparatus includes, as a plurality of pairs of rotators, a first pair of rollers (a first pair of rotators) and a second pair of rollers (a second pair of rotators) which are provided on the downstream side in the conveyance direction from the first pair of rollers, which will be described below.

The first pair of rollers include a first drive roller serving as a first rotatable roller and a first pressure roller which is pressed to the first drive roller to form a nip portion and conveys the sheet by being nipped in the nip portion.

The second pair of rollers are provided on the downstream side in the conveyance direction from the first pair of rollers. The second pair of rollers include a second drive roller serving as a second rotatable roller and a second pressure roller which is pressed to the second drive roller to form a nip portion and conveys the sheet by being nipped in the nip portion.

The first sheet pulling and conveying apparatus 101 nips and conveys the sheet P by a first drive roller 104 and a first pressure roller 105 forming the first pair of rotators, and a second drive roller 106 and a second pressure roller 107 forming the second pair of rotators. The second sheet pulling and conveying apparatus 201 nips and conveys the sheet P by a first drive roller 204 and a first pressure roller 205 forming the first pair of rotators, and a second drive roller 206 and a second pressure roller 207 forming the second pair of rotators. The third sheet pulling and conveying apparatus 301 nips and conveys the sheet P by a first drive roller 304 and a first pressure roller 305 forming the first pair of rotators, and a second drive roller 306 and a second pressure roller 307 forming the second pair of rotators. The sheet pulling and conveying apparatuses 101, 201, and 301 each apply a tensile force on the sheet P to extend the center portion of the sheet P in the width direction while sequentially conveying the sheet P.

The first drive rollers 104, 204, and 304, the first pressure rollers 105, 205, and 305, the second drive rollers 106, 206, and 306, and the second pressure rollers 107, 207, and 307 are configured to include elastic rubbers 104b, 105b, 106b, 107b, 204b, 205b, 206b, 207b, 304b, 305b, 306b, and 307b such as silicon, NBR, and EPDM on the surface layers of roller shafts 104a, 105a, 106a, 107a, 204a, 205a, 206a, 207a, 304a, 305a, 306a, and 307a formed of a high rigidity material such as stainless steel or steel.

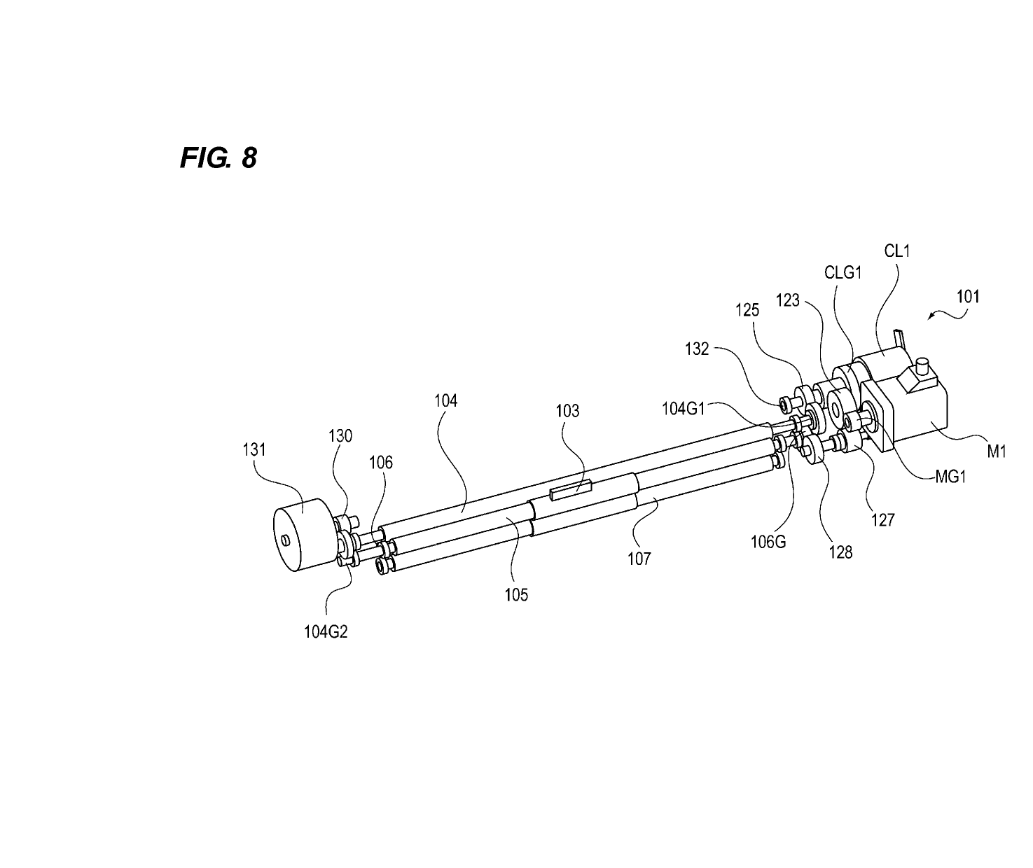

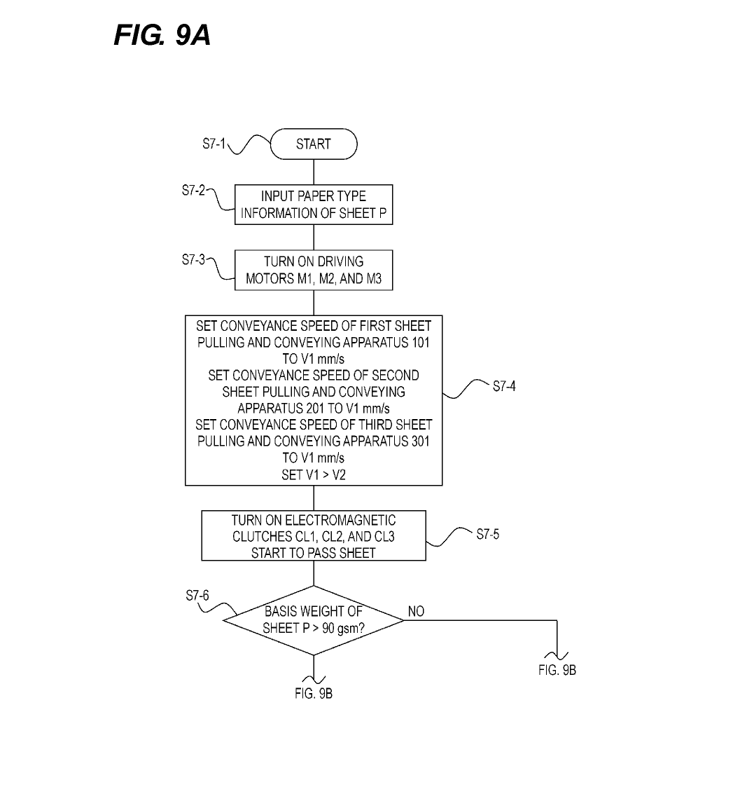

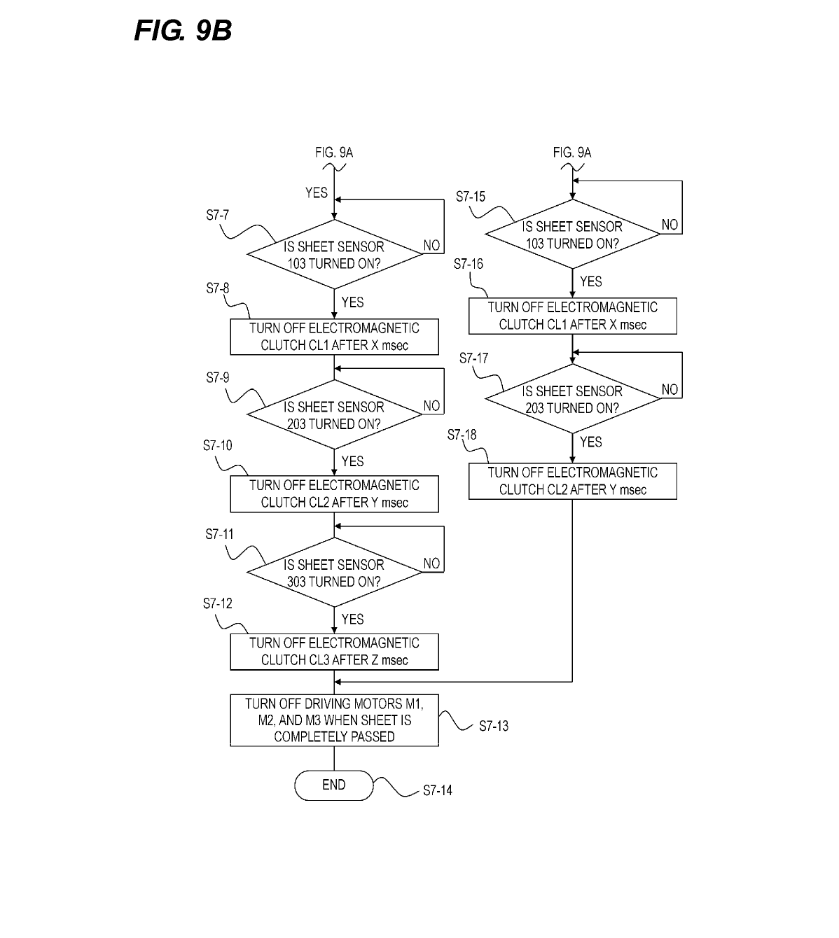

In addition, as illustrated in FIG. 6, the elastic rubbers 105b, 107b, 205b, 207b, 305b, and 307b of the first pressure rollers 105, 205, and 305 and the second pressure rollers 107, 207, and 307 are formed in an area corresponding to a length of L1 in the center portion in the width direction of the sheet to be uniformly disposed with respect to a sheet feeding center (the center in the width direction). Herein, the sheet feeding center indicates a position at the center in the width direction which is a reference when the sheet is conveyed. The length L1 is shorter than the width (the length in the width direction of the sheet having a predetermined size) of the sheet P having a rippling problem illustrated in FIG. 8. In the embodiment, L1 is set to 100 mm (L1=100 mm). A predetermined size of the sheet corresponds to a sheet which is frequently used in the apparatus; for example, an A3 sheet (297 mm) corresponds thereto. In this way, the elastic rubbers 105b, 107b, 205b, 207b, 305b, and 307b are disposed in the center portion of the width direction. Therefore, the first drive roller 104 and the first pressure roller 105 form a nip portion in the center portion of the width direction. Similarly, the nip portion between the first drive roller 204 and the first pressure roller 205, and the nip portion between the first drive roller 304 and the first pressure roller 305 are formed in the center portion in the width direction. In addition, the second drive roller 106 and the second pressure roller 107 are configured to form a nip portion in the center portion in the width direction. Similarly, a nip portion between the second drive roller 206 and the second pressure roller 207, and a nip portion between the second drive roller 306 and the second pressure roller 307 are also formed in the center portion in the width direction.

Further, in the embodiment, elastic rubber portions are formed in the center portion in the width direction of the first pressure rollers 105, 205, and 305 and the second pressure rollers 107, 207, and 307, but the invention is not limited thereto. The elastic rubber portions may be formed in the center portion in the width direction of the first drive rollers 104, 204, and 304 and the second drive rollers 106, 206, and 306.

In addition, conveyance guides 114, 115, 214, 215, 314, and 315 serving as guide members to guide the sheet are provided between the nip portions of the first pair of rollers and the second pair of rollers, and a distance between the nip portions is 25 mm.

The first drive rollers 104, 204, and 304 and the second drive rollers 106, 206, and 306 are configured such that both ends of the roller shafts 104a, 106a, 204a, 206a, 304a, and 306a are supported to drive-side plates 119, 219, and 319 through bearing members (not illustrated).

The first pressure rollers 105, 205, and 305 are configured such that both ends of the roller shafts 105a, 205a, and 305a are supported to a pressure plate 112 through bearing members (not illustrated). In addition, the first pressure rollers 105, 205, and 305 are biased between the pressure plate 112 and the bearing members (not illustrated) by first pressure springs 109, 209, and 309. With this configuration, the first pressure rollers 105, 205, and 305 are pressed to the first drive rollers 104, 204, and 304, so that first nip portions N11, N12, and N13 are formed. In the embodiment, the first pressure springs 109, 209, and 309 are provided to have a biasing force to apply a pressing force of about 39 N (4 kgf).

The second pressure rollers 107, 207, and 307 are configured such that both ends of the roller shafts 107a, 207a, and 307a are supported to the pressure plate 112 through the bearing members (not illustrated). In addition, the second pressure rollers 107, 207, and 307 are biased between the pressure plate 112 and the bearing members (not illustrated) by second pressure springs 108, 208, and 308. With this configuration, the second pressure rollers 107, 207, and 307 are pressed to the second drive rollers 106, 206, and 306, so that second nip portions N21, N22, and N23 are formed. In the embodiment, the second pressure springs 108, 208, and 308 are provided to have a biasing force to apply a pressing force of about 39 N (4 kgf).

### <Description of Driving>

Herein, the driving of the first drive rollers 104, 204, and 304 and the second drive rollers 106, 206, and 306 will be described using FIGS. 6 and 7. FIGS. 6 and 7 are a perspective view and a side view for describing the driving of the first drive rollers 104, 204, and 304 and the second drive rollers 106, 206, and 306.

The driving of the sheet pulling and conveying apparatus 101 will be described using FIG. 8. FIG. 8 is a perspective view for describing the driving of the first drive roller 104 and the second drive roller 106 which are included in the sheet pulling and conveying apparatus 101. The sheet pulling and conveying apparatuses 201 and 301 have the same configuration as the sheet pulling and conveying apparatus 101, and the driving configuration thereof will not be repeated.

### <Driving of Plurality of Pulling and Conveying Apparatuses>

Referring to FIGS. 6 to 8, the first drive rollers 104, 204, and 304 and the second drive rollers 106, 206, and 306 are rotated by receiving a rotary driving force from motor gears MG1, MG2, and MG3 of driving motors M1, M2, and M3 serving as drive sources. The first drive roller 104 is rotated by receiving the rotary driving force through a driving transmission gear 123, a clutch gear CLG1, and driving transmission gears 124, 125, and 104G1. The first drive roller 204 is rotated by receiving the rotary driving force through a driving transmission gear 223, a clutch gear CLG2, and driving transmission gears 224, 225, and 204G1. The first drive roller 304 is rotated by receiving the rotary driving force through a driving transmission gear 323, a clutch gear CLG3, and driving transmission gears 324, 325, and 304G1. The second drive roller 106 is rotated by receiving the rotary driving force through the driving transmission gears 123, 127, 128, and 129. The second drive roller 206 is rotated by receiving the rotary driving force through the driving transmission gears 223, 227, 228, and 229. The second drive roller 306 is rotated by receiving the rotary driving force through the driving transmission gears 323, 327, 328, and 329.

The first pressure rollers 105, 205, and 305 and the second pressure rollers 107, 207, and 307 each press the first drive rollers 104, 204, and 304 and the second drive rollers 106, 206, and 306. The first pressure rollers 105, 205, and 305 and the second pressure rollers 107, 207, and 307 each are driven along the rotations of the first drive rollers 104, 204, and 304 and the second drive rollers 106, 206, and 306.

The driving transmission gear 124 is provided with a one way clutch (not illustrated). The one way clutch is locked when the first drive roller 104 rotates in the conveyance direction of the sheet P by the driving of the driving motor M1, and transmits the driving of the driving motor M1 to the first drive roller 104. Further, similarly the first drive roller 204 (304) is also provided with the one way clutch in a path for transmitting a driving force with respect to the driving motor M2 (M3). The one way clutch is locked when the first drive roller 204 rotates in the conveyance direction of the sheet P by the driving of the driving motor M2, and transmits the driving of the driving motor M2 to the first drive roller 204. In addition, the one way clutch is locked when the first drive roller 304 rotates in the conveyance direction of the sheet P by the driving of the driving motor M3, and transmits the driving of the driving motor M3 to the first drive roller 304.

In addition, as illustrated in FIG. 7, drive gears 104G2, 204G2, and 304G2 are fixed to the other ends of the first drive rollers 104, 204, and 304, and connected to torque applying apparatuses 131, 231, and 331 (load portions) through the driving transmission gears 130, 230, and 330.

The function of the torque applying apparatuses 131, 231, and 331 will be described.

For example, the description will be given using the configuration of the sheet pulling and conveying apparatus 101. In this case, it is assumed that a driving force is transferred to the first drive roller 104 and the second drive roller 106, and the sheet P is nipped between the first drive roller 104 and the first pressure roller 105, nipped between the second drive roller 106 and the second pressure roller 107, and conveyed. A load by the torque applying apparatus is not applied on the first drive roller 104 during a period when the driving force is transferred from the driving motor M1 to the first drive roller 104. When the transmission of the driving force from the driving motor M1 to the first drive roller 104 is disconnected by an electromagnetic clutch CL, the sheet P is conveyed by a conveyance force of the second drive roller 106 and the second pressure roller 107. Since the one way clutch is disposed between the first drive roller 104 and the driving motor M1, when the sheet P is conveyed by the conveyance force of the second drive roller 106 and the second pressure roller 107, the first drive roller 104 receives a force from the sheet P and rotates. At this time, the torque applying apparatus 131 applies a load on the rotation of the first drive roller 104. When the load is applied on the rotation of the first drive roller 104, a tensile stress is generated in the sheet P nipped between the first drive roller 104 and the first pressure roller 105 and between the second drive roller 106 and the second pressure roller 107.

In other words, it is possible to control whether to generate the tensile stress in the sheet P by controlling whether to apply a driving force to the first drive roller 104.

Further, the torque applying apparatuses 231 and 331 of the second sheet pulling and conveying apparatus 201 and the third sheet pulling and conveying apparatus 301 have the same function.

Herein, the torque applying apparatuses 131, 231, and 331 may be configured by anything as long as it can apply a driving load on the first drive rollers 104, 204, and 304 (for example, the load portion such as an electromagnetic brake or a brake pad). In the embodiment, in a case where the same sheet P is present in both of the first nip portions N11, N12, and N13 and the second nip portions N21, N22, and N23, a setting value of the torque applying apparatus is set to make a tension applied onto the sheet P become about 68 N (7 kgf). The setting values of the torque applying apparatuses 131, 231, and 331 are set in a range where the sheet P is not damaged while a sufficient tension is applied onto the sheet P.

### <Clutch Mechanism>

FIG. 8 is a perspective view for describing about the driving of the first drive roller 104 and the second drive roller 106. Further, the CPU (see FIG. 3) as a controller controls the operations of an electromagnetic clutch CL1 (CL2 and CL3) as a clutch portion (a drive controller) and the driving motor M1 (M2 and M3) as a drive portion according to a signal of a sheet sensor 103 (203 and 203).

As illustrated in FIG. 8, a drive gear 104G1 and a drive gear 106G are held and fixed to one ends of the first drive roller 104 and the second drive roller 106. The first drive roller 104 is rotated by receiving a rotary driving force through the driving transmission gear 123, the clutch gear CLG1, the driving transmission gear 125, and the drive gear 104G1 by the motor gear MG1 of the driving motor M1 serving as a drive source. The second drive roller 106 is rotated by receiving a rotary driving force through the driving transmission gears 127, 128, and 106G by the motor gear MG1 of the driving motor M1 serving as a drive source. The first pressure roller 105 and the second pressure roller 107 pressed by the first drive roller 104 and the second drive roller 106 are rotated along the rotation of the first drive roller 104 and the second drive roller 106.

The clutch gear CLG1 is fixed to the electromagnetic clutch CL1. When the electromagnetic clutch CL1 is powered on, a driving force between the clutch gear CLG1 and the driving transmission gear 123 is transferred through a clutch shaft 132, and the first drive roller 104 rotates. On the other hand, when the electromagnetic clutch CL1 is not powered on, the driving force between the clutch gear CLG1 and the driving transmission gear 123 is not transferred, the driving force of the driving motor M1 is not transferred up to the drive gear 104G and thus the first drive roller 104 does not rotate.

In addition, the drive gear 104G2 is fixed to the other end of the first drive roller 104, and connected to a load portion 131 such as the torque applying apparatus and an electromagnetic brake through the driving transmission gear (a driving force transfer member) 130.

### <Arrangement of Plurality of Pulling and Conveying Apparatuses>

In the following, a relation between at least two sheet pulling and conveying apparatuses (101, 201, and 301) will be described. In the embodiment, as at least two sheet pulling and conveying apparatuses, a configuration in which three sheet pulling and conveying apparatuses 101, 201, and 301 are provided in the lengthwise direction (gravitational direction, vertical direction) in the sheet conveying direction as illustrated in FIG. 1 will be described.

Providing at least two sheet pulling and conveying apparatuses is to sufficiently obtain pulling effect in the conveyance direction of the sheet P. The pulling effect of the sheet P can be increased by increasing a tension between the first nip portion N11 and the second nip portion N21, between the first nip portion N12 and the second nip portion N22, and between the first nip portion N13 and the second nip portion N23. However, when the tension (the tensile stress of the sheet conveying direction) is excessively increased and thus a stress on the sheet P is steeply applied, the damage on the sheet P becomes large, so that there is a possibility to degrade the quality of a resultant product. The reason is that since a time taken for the sheet to pass through the sheet pulling and conveying apparatus is shortened as the apparatus is increased in speed in recent years, the tensile stress is increased, and further when the tensile stress is steeply applied to the sheet, a large stress is applied on the sheet, so that there is a possibility to damage the sheet.

In addition, since a large load is required to pull the second drive roller 206 out of the first nip portion N11, slipping occurs in the second nip portion N21, so that there is a possibility to cause a variation in the pulling effect of the sheet P or a variation in the conveyance speed. For this reason, at least two sheet pulling and conveying apparatuses are provided to extend the sheet P in multiple stages, so that it is possible to make the pulling effect for the sheet P without these defects. In the embodiment, when a tension of 98 N (10 kgf) or more is applied for example, the damage on the sheet P becomes large, and the quality of the resultant product is degraded. Therefore, the tension setting values of the torque applying apparatuses 131, 231, and 331 are set to about 68 N (7 kgf), and the plurality of sheet pulling and conveying apparatuses 101, 201, and 301 are provided.

In addition, the sheet P discharged from the fixing apparatus 100 or the sheet pulling and conveying apparatuses 101 and 201 on the upstream side in the conveyance direction is generated with curling in different directions and amounts according to basis weight, stiffness, a moisture amount or image pattern, an environmental condition of the sheet P. In particular, the curling is likely generated in the sheet P weak in stiffness. With this regard, the first sheet pulling and conveying apparatus 101, the second sheet pulling and conveying apparatus 201, and the third sheet pulling and conveying apparatus 301 are disposed in an order of the first sheet pulling and conveying apparatus 101, the second sheet pulling and conveying apparatus 201, and the third sheet pulling and conveying apparatus 301 from the upside in the gravitational direction. Then, the sheet P is conveyed in the order of the first sheet pulling and conveying apparatus 101, the second sheet pulling and conveying apparatus 201, and the third sheet pulling and conveying apparatus 301. In addition, the respective sheet pulling and conveying apparatuses are disposed such that a straight line connecting the first nip portion N11 and the second nip portion N21 of the first sheet pulling and conveying apparatus 101, a straight line connecting the first nip portion N12 and the second nip portion N22 of the second sheet pulling and conveying apparatus 201, and a straight line connecting the first nip portion N13 and the second nip portion N23 of the third sheet pulling and conveying apparatus 301 are located in the substantially same straight line. With this configuration, since the sheet P is conveyed along the gravitational direction, even in a case where a plurality of sheet pulling and conveying apparatuses are provided, the sheet can be stably transferred between the respective sheet pulling and conveying apparatuses 101, 201, and 301 in a state of a less influence of the curling.

In addition, with the above arrangement, it is possible to prevent that the sheet is bent between the plurality of sheet pulling and conveying apparatuses 101, 201, and 301 due to the curling, the curling of the sheet is intensified due to the stress from the guide, and damage occurs in the image.

### <Problem in Switching by Basis Weight>

As described above, the reason why the plurality of sheet pulling and conveying apparatuses are provided is to obtain the sufficient pulling effect of the sheet P. The tension setting values of the torque applying apparatuses 131, 231, and 331 are set to about 68 N (7 kgf) so that the tension applied by the respective sheet pulling and conveying apparatuses does not cause damage on the sheet P, and the plurality of sheet pulling and conveying apparatuses 101, 201, and 301 are provided.

However, when the sheet passes through the sheet pulling and conveying apparatus in many times, depending on a physical property of the sheet P, there may be a problem in that the sheet length in the vicinity of the center portion of the sheet P is extended further more compared to the vicinity of the end portion thereof. The corresponding example will be described below.

### <Measuring Method of Rippling>

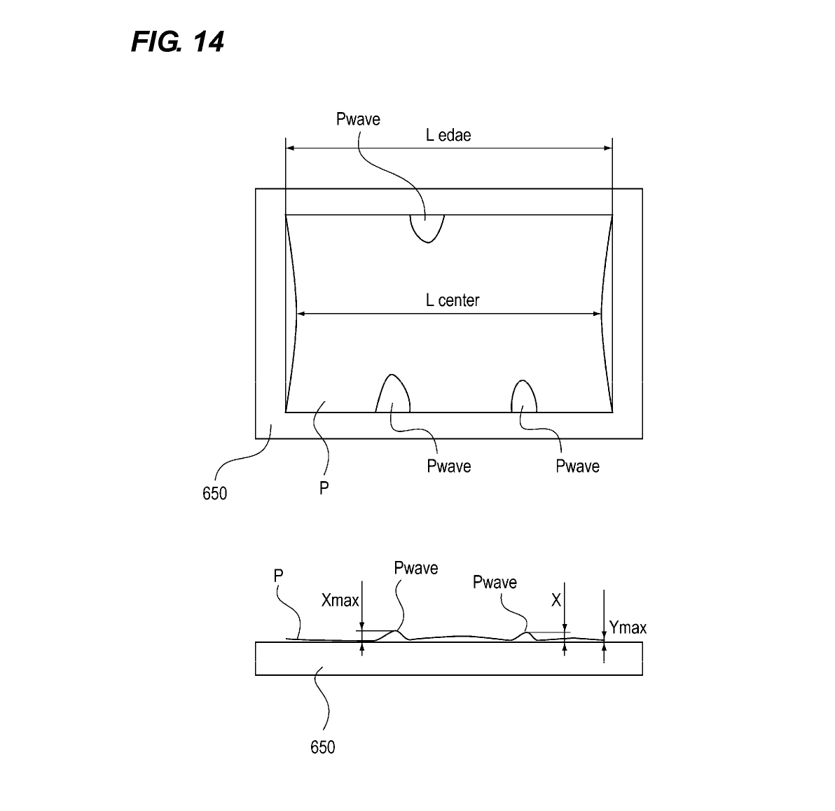

A feature of the shape of the curling and the end rippling generated in the sheet P and a measuring method thereof will be described with reference to FIG. 14. The sheet P passing through only the nip portion N of the fixing apparatus 100 is placed on a measurement plate 650 illustrated in FIG. 14. Alternatively, after passing through the nip portion N of the fixing apparatus 100, the sheet P passing on through the first sheet pulling and conveying apparatus 101, the second sheet pulling and conveying apparatus 201, and the third sheet pulling and conveying apparatus 301 as illustrated in FIG. 1 is placed on the measurement plate 650 illustrated in FIG. 14. Herein, the length of the end portion of the sheet P in the sheet conveying direction is set to L edge [mm], and the length of the center portion is set to L center [mm].

In addition, the upper side or the lower side of the sheet P illustrated in FIG. 14, that is, a bent shape Pwave generated at the end portion in the width direction perpendicular to the conveyance direction is referred to as an end rippling. Among the bent shapes, a bent shape X max having the largest gap with respect to the measurement plate 650 is set to an evaluation target as a rippling amount. In addition, among four corners of the sheet P, a corner Y max having a maximum distance from the measurement plate 650 is set to an evaluation target as a maximum curling amount.

### <Relation Between Pulling Cycle and Extension of Center Portion>

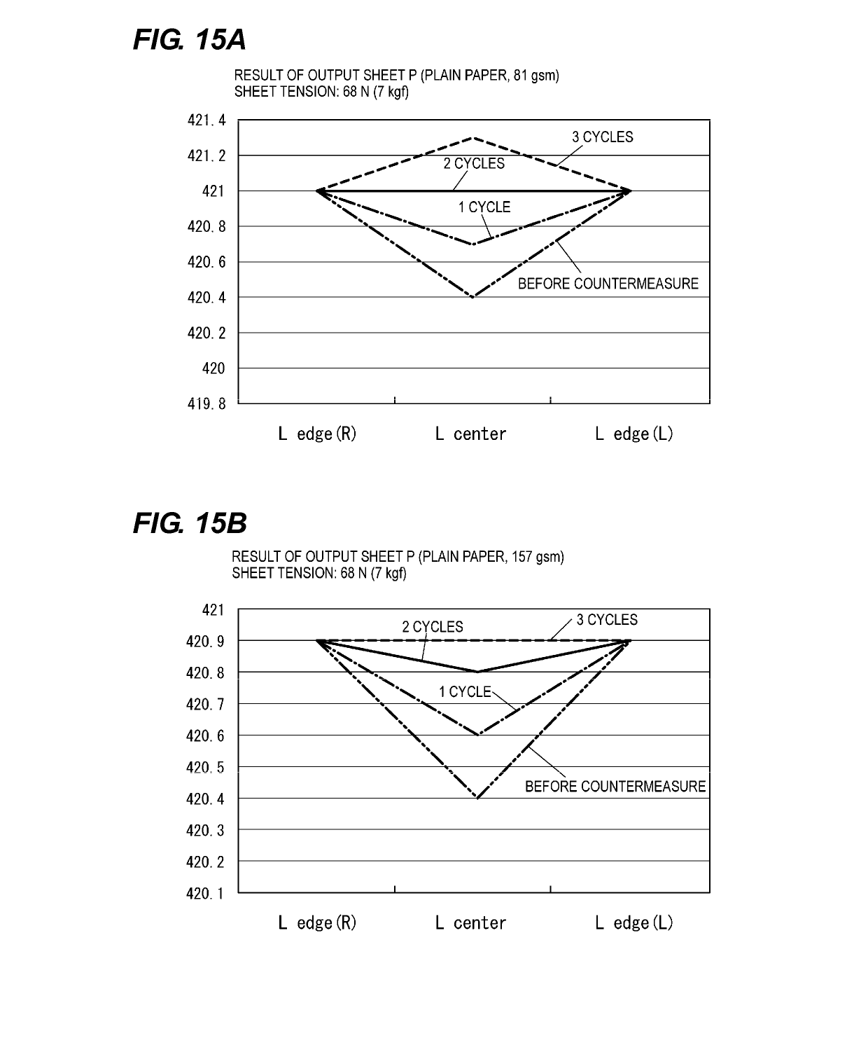

FIGS. 15A and 15B illustrate fundamental experiment results obtained by measuring the pulling cycle and a change in length of the center portion and the end portion of the sheet P using the first sheet pulling and conveying apparatus 101 in the embodiment performed by the inventors.

FIGS. 15A and 15B shows the experiment results performed on the sheets P (plain paper) of which the basis weight is 81 gsm and 157 gsm. In this case, the tension applied by the first sheet pulling and conveying apparatus 101 on the sheet P was 68 N (7 kgf).

Specifically, regarding the measurement of the length of the sheet P, the lengths L edge [mm] (L edge(R) and L edge(L)) of the right and left end portions of the sheet P illustrated in FIG. 14 and the length L center [mm] of the center portion were measured.

In addition, in a case where the sheet humidification apparatus 400 of the embodiment is passed under the above fundamental experiment conditions, the sheet moisture amount immediately after passing was set to 7% or more.

The moisture measurement of the sheet in the embodiment was measured by the inventors using the sheet P immediately after the sheet P passed through the sheet rippling correction apparatus 900 and discharged onto the discharge tray 565. In the embodiment, a microwave type of paper moisture meter was used.

The respective measurement data will be described. The length immediately after the sheet passed through the fixing apparatus 100 is depicted by a two-dotted chain line “Before Countermeasure”. In addition, a result when the sheet passed only through the first sheet pulling and conveying apparatus 101 is depicted by a chain line “1 Cycle”, a result when the sheet passed through the first sheet pulling and conveying apparatus 101 for two cycles is depicted by a solid line“2 Cycles”, and a result when the sheet passed through the first sheet pulling and conveying apparatus 101 for three cycles is depicted by a dotted line “3 Cycles”.

As illustrated in FIGS. 15A and 15B in which the results on the plain paper having a basis weight of 81 gsm and the plain paper having a basis weight of 157 gsm are plotted, the length of the end portion of the sheet P immediately after passing through the fixing apparatus 100 is longer than the center portion as illustrated in graph of the two-dotted chain line (before countermeasure), respectively. In the drawing, L edge(R) and L edge(L) represent the end portions of the sheet P, and L center represents the center portion of the sheet P. The end portions of the plain paper having a basis weight of 81 gsm and the plain paper having a basis weight of 157 gsm were longer the than the center portions by 0.6 mm and 0.5 mm, respectively. As described above, the reason is that in a case where the fixing apparatus is provided with a wide nip portion, the end portion of the sheet in the width direction after being discharged from the nip portion is extended in the conveyance direction further more compared to the center portion. In the fixing apparatus provided with the wide nip portion, wrinkles of the sheet are prevented in process of passing through the nip portion. Therefore, in the nip portion, the conveyance speed on the end side is set to be higher than the center portion of the sheet in the width direction, so that the pulling action is applied to the sheet. For this reason, in the case of the fixing apparatus provided with the wide nip portion, the end portion of the sheet in the width direction after being discharged is extended in the conveyance direction further more compared to the center portion.

First, the result on the plain paper of 157 gsm will be described using FIG. 15B. The center portion is extended by 0.2 mm, 0.2 mm, and 0.1 mm in an order of “1 Cycle” depicted by the chain line, “2 Cycles” by the solid line, “3 Cycles” by the dotted line according to the number of sending the sheets to pass through the sheet pulling and conveying apparatus 101 illustrated in the embodiment. From the result, it can be seen that 3 cycles of extending is necessary for correcting a difference in length between the center portion and the end portion of the sheet by applying the tensile stress (tension) to the sheet P.

Next, the result of the plain paper of 81 gsm will be described using FIG. 15A. The center portion is extended by 0.3 mm in an order of “1 Cycle” depicted by the chain line, “2 Cycle” by the solid line, and “3 Cycles” by the dotted line according to the number of sending the sheets to pass through the sheet pulling and conveying apparatus 101 illustrated in the embodiment. From the result, it can be seen that a difference in length between the end portion and the center portion of the sheet P can be corrected by extending the center portion of the sheet. As shown in the result of “2 Cycles” depicted by the solid line, when the tension force is applied to the sheet P for two cycles in the sheet pulling and conveying apparatus (101, 201, and 301), the difference between the end portion and the center portion of the sheet P can be corrected to be 0 mm.

However, as can be seen from the result of “3 Cycles” of passing the sheet through the sheet pulling and conveying apparatuses 101, 201, and 301, the length in the vicinity of the center portion of the sheet P exceeds the length of the end portion. From the result, when the tensile stress (tension) is applied to the plain paper of 81 gsm and extended for 3 cycles similarly to the plain paper of 157 gsm, a correction amount in the vicinity of the center portion of the sheet P is excessively increased.

As described above, in a case where the plurality of apparatuses such as the sheet pulling and conveying apparatuses 101, 201, and 301 are disposed with respect to the sheet P, when there is no control on the number of pulling cycles according to the paper type, the correction amount in the vicinity of the center portion of the sheet P is excessively increased.

As a countermeasure, the tension applied by the sheet pulling and conveying apparatuses 101, 201, and 301 onto the sheet P is switched according to the information of the sheet P.

In the embodiment, the basis weight of the sheet P is used as the information on the sheet P (switching information of tension application). Specifically, in the paper type of the sheet P of which the basis weight is larger than 90 gsm, the rippling is corrected by applying the tension to the sheet P by the sheet pulling and conveying apparatuses 101, 201, and 301 for 3 cycles. On the other hand, in the paper type of the sheet of which the basis weight is equal to or less than 90 gsm, the tension is applied only by the sheet pulling and conveying apparatuses 101 and 201 for 2 cycles, and the sheet is conveyed by the sheet pulling and conveying apparatus 301 without applying the tension, so that the rippling is corrected. The operation of the drive control will be described below.

Further, herein, paper type information of the sheet P in the sheet cassette 520 is input by a user through an operation panel 570 (see FIG. 2), and is sent to the controller 500C which includes the CPU and the memory in the printer 500 illustrated in FIG. 3. Alternatively, the information on the sheet P may be detected by a detection sensor 500D which is provided above the sheet cassette 520 in the printer 500, and the detected information may be sent to the controller 500C which includes the CPU and the memory. Alternatively, the information on the sheet may be input from an external computer connected to the printer 500. The operation panel, the detection sensor, and the external computer are examples of an acquisition portion which acquires the information on the sheet. Further, the paper type information is sent from the controller 500C to the controller 901C of the sheet rippling correction apparatus 900.

### <Flowchart>

Hereinafter, a sequence of the drive control of the embodiment will be described using FIGS. 3, 9, and 10 to 13.

Further, in the following description, the basis weight of the sheet is used as the information on the sheet. In addition, 90 gsm is exemplified as the basis weight of the sheet P. Further, a basis weight equal to or less than 90 gsm is referred to as a first basis weight, and a basis weight larger than 90 gsm is referred to as a second basis weight.

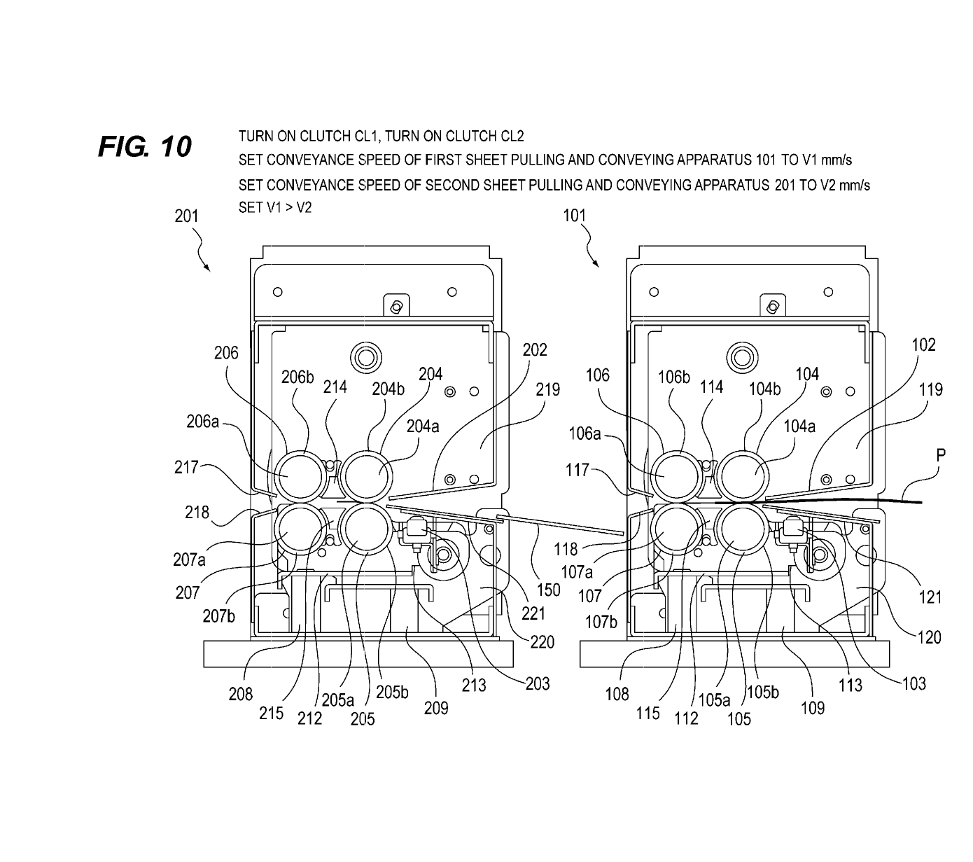

FIG. 3 is a block diagram relating to the drive control of the embodiment. FIGS. 9A and 9B illustrate flowcharts relating to the drive control of the embodiment. FIGS. 10 to 13 illustrate cross-sectional views of the sheet pulling and conveying apparatuses 101 and 201, when viewed from the front side, for describing the drive control of the embodiment. Herein, the sheet pulling and conveying apparatus 301 operates in the same manner as the sheet pulling and conveying apparatus 201, and the description thereof will not be repeated.

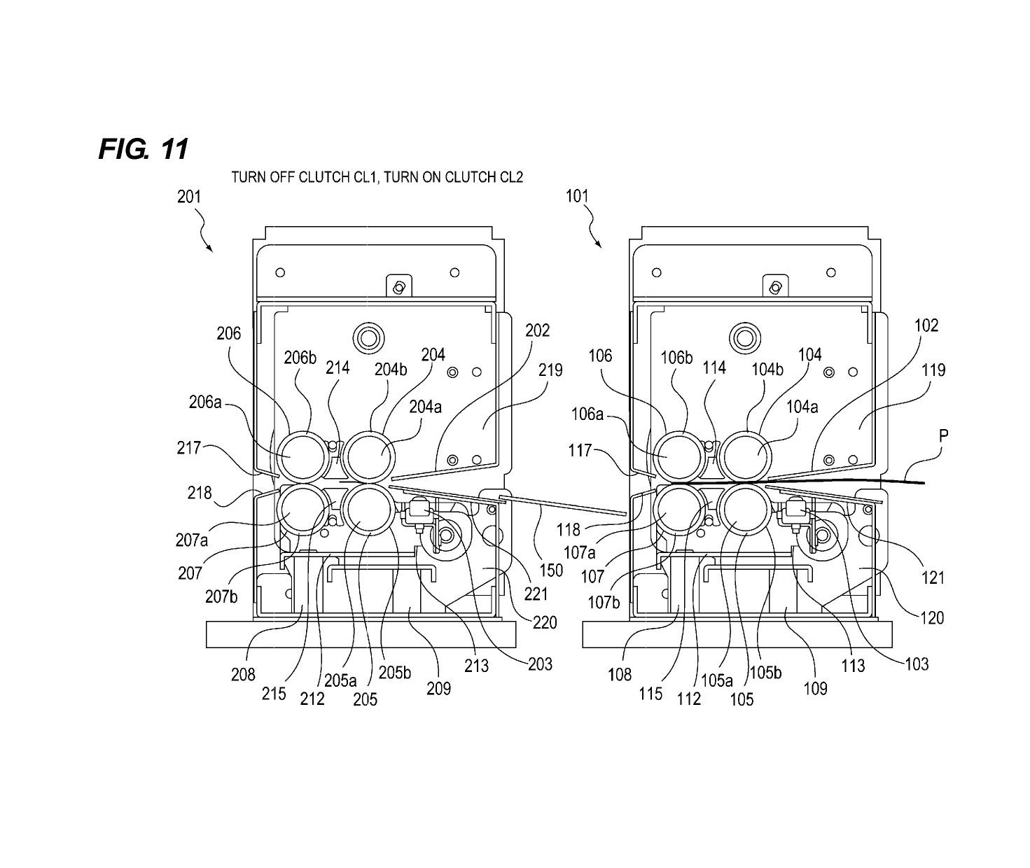

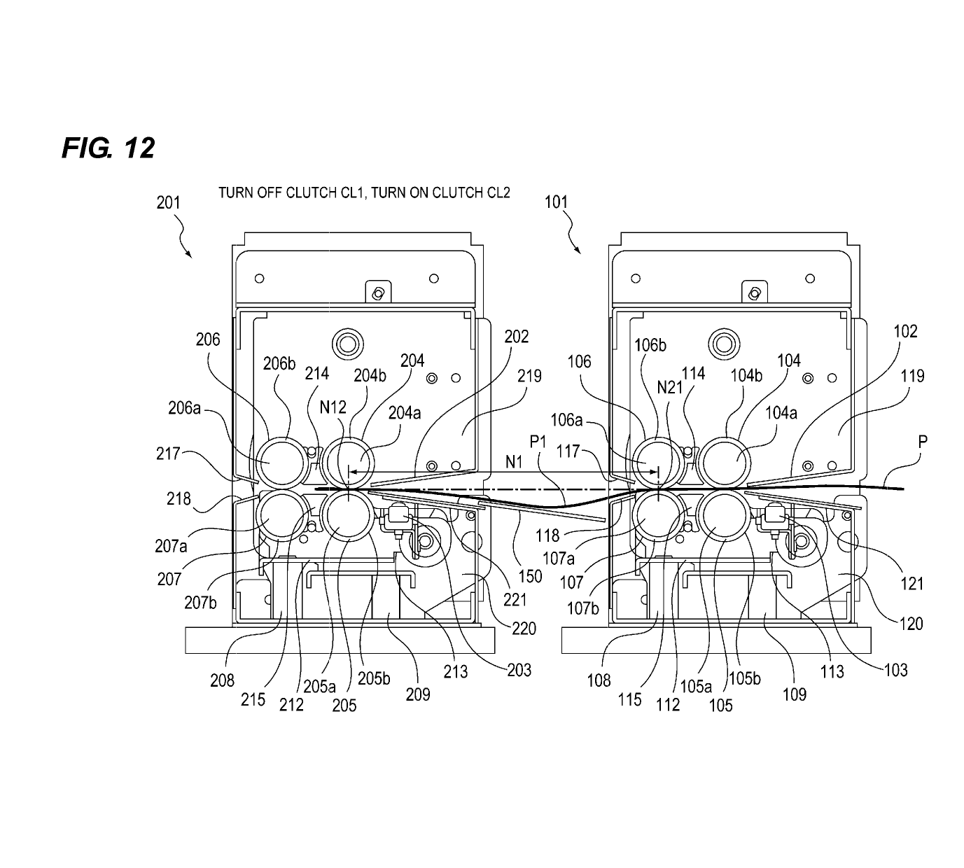

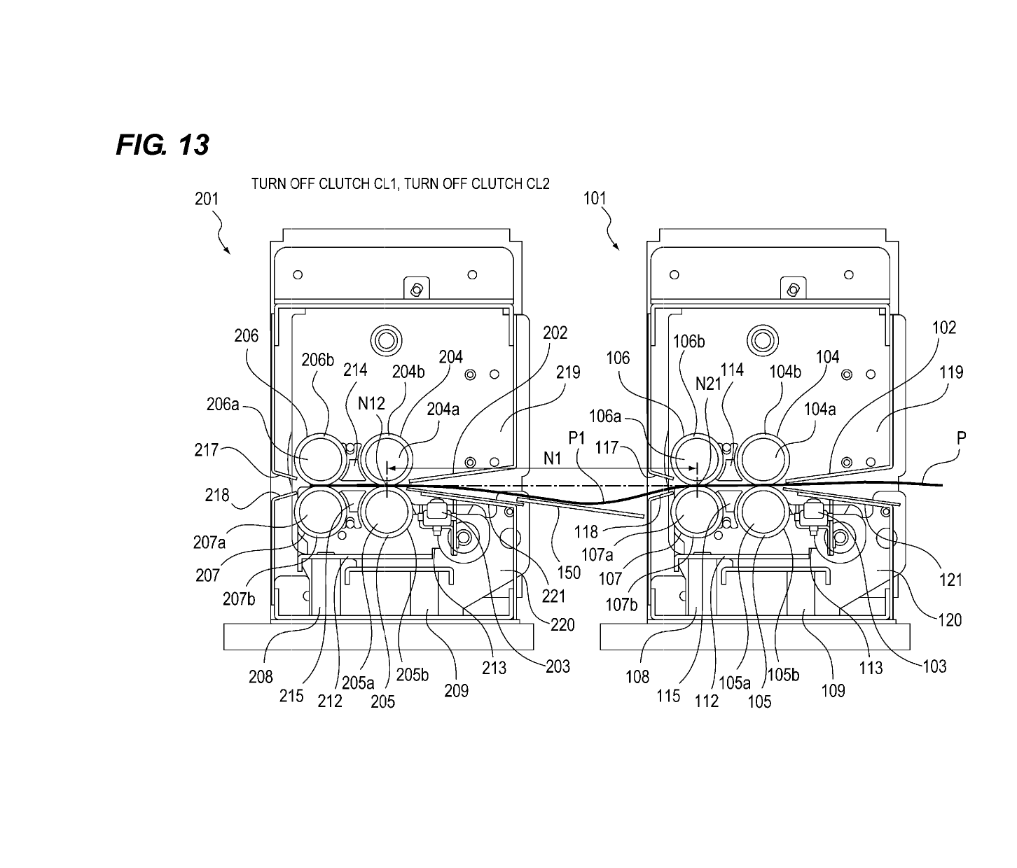

FIG. 10 is a cross-sectional view at the time of 0 to X msec after the sheet sensor 103 is turned on when viewed from the front side, and FIG. 11 is a cross-sectional view at the time of X msec after the sheet sensor 103 is turned on when viewed from the front side. FIG. 12 is a cross-sectional view at the time of 0 to Y msec after the sheet sensor 203 is turned on when viewed from the front side, and FIG. 13 is a cross-sectional view at the time of Y msec after the sheet sensor 203 is turned on when viewed from the front side.

After a sheet-passing job signal 51 is input to the CPU (the controller 500C) (S7-1), the paper type information (basis weight) of the sheet P is input to the CPU (the controller 500C) (S7-2), and the driving motors M1, M2, and M3 are powered on (S7-3). The driving motors M1, M2, and M3 are set such that the respective conveyance speeds of the sheet pulling and conveying apparatuses 101, 102, and 103 become V1 [mm/s], V2 [mm/s], and V3 [mm/s] and satisfies a relation of V1>V2>V3. The conveyance speed V1 [mm/s] of the first sheet pulling and conveying apparatus 101 is the rotation speeds of the first drive roller 104 and the second drive roller 106. The conveyance speed V2[mm/s] of the second sheet pulling and conveying apparatus 201 is the rotation speeds of the first drive roller 204 and the second drive roller 206. The conveyance speed V3[mm/s] of the third sheet pulling and conveying apparatus 301 is the rotation speeds of the first drive roller 304 and the second drive roller 306. In the embodiment, the speed V2 is set to be slower than the speed V1 by 0.5%, and the speed V3 is set to be slower than the speed V2 by 0.5% (for example, V1=300 mm/s, V2=298.5 mm/s, and V3=297 mm/s) (S7-4). In the embodiment, the rotation speeds of the driving motors M1 and M2 are changed by a speed reduction ratio of the drive gear, so that the conveyance speeds V1, V2, and V3 are achieved.

Immediately after the driving motors M1, M2, and M3 are turned on, the electromagnetic clutches CL1, CL2, and CL3 are also powered on, and the sheet starts to pass (S7-5). As a result, as described above, the driving forces of the driving motors M1 and M2 are transferred to the drive gears 104G1, 204G1, 304G1, 106G, 206G, and 306G through the driving transmission gears, so that the first drive rollers 104, 204, and 304 and the second drive rollers 106, 206, and 306 are rotated.

The controller 901C of the sheet rippling correction apparatus 900 switches the control on the sheet pulling and conveying apparatuses 101, 201, and 301 according to the paper type information of the sheet P which is input by the user (S7-6). Hereinafter, the switching of the control according to the basis weight of the sheet as the paper type information of the sheet P will be described.

First, the description will be made about the case of the paper type of which the basis weight of the sheet P is larger than 90 gsm.

When the sheet P is guided to the inlet guides 102 and 121 in the first sheet pulling and conveying apparatus 101 and an ON signal of the sheet sensor 103 is confirmed (S7-7), the electromagnetic clutch CL1 is powered off after X msec (S7-8). The value X is set as a time taken for turning on the sheet sensor 103 immediately after the leading end of the sheet P is nipped in the nip portion of the second pair of rollers of the first sheet pulling and conveying apparatus 101. The value X is determined by the conveyance speed V1 of the sheet P of the first sheet pulling and conveying apparatus 101 and a distance from the sheet sensor 103 to the nip portion of the second pair of rollers. In the embodiment, the conveyance speed V1 of the sheet P of the first sheet pulling and conveying apparatus 101 is 300 mm/s, and the distance from the sheet sensor 103 to the nip portion of the second pair of rollers is 45 mm, so that X is set to 160 msec.

When the electromagnetic clutch CL1 is powered off after X msec elapses since the sheet sensor 103 is turned on, the driving force to the first drive roller 104 is released. In other words, as illustrated in FIG. 10, since the electromagnetic clutch CL1 is in an ON state for a time from 0 to X msec after the sheet sensor 103 is turned on, the driving force is transferred to the first drive roller 104 to convey the sheet P. Thereafter, as illustrated in FIG. 11, at the time of X msec after the sheet sensor 103 is turned on, the leading end of the sheet P just reaches the nip portion of the second pair of rollers of the first sheet pulling and conveying apparatus 101, and the sheet P is conveyed by the driving force of the second drive roller 106. At the same time, since the electromagnetic clutch CL1 enters an OFF state and the driving force is not transferred to the first drive roller 104, the first pair of rollers of the first sheet pulling and conveying apparatus 101 are rotatably driven. In addition, since the first drive roller 104 is connected to the load portion 131 through the drive gear 104G2 and the driving transmission gear 130, a torque load is generated in order to rotate the first drive roller 104. As a result, in FIG. 11, the sheet P is conveyed between the first pair of rollers and the second pair of rollers while a tension force is generated on the sheet P. In the embodiment, the load torque of the load portion 131 is set to cause the tension force applied on the sheet P to be about 59 N (about 6 kgf).

In addition, in the embodiment, as illustrated in FIG. 6, the nip portion between the first pair of rollers and the second pair of rollers of the first sheet pulling and conveying apparatus 101 is configured to have a width (length L1) of 100 mm in the center portion in the width direction perpendicular to the sheet conveying direction. With this configuration, a tension force of about 59 N (about 6 kgf) is applied only to the center portion in the width direction from the leading end to the rear end of the sheet P.

Thereafter, when the sheet P is guided to inlet guides 202 and 221 in the second sheet pulling and conveying apparatus 201 and the ON signal of the sheet sensor 203 is confirmed (S7-9), the electromagnetic clutch CL2 is powered off after Y msec (S7-10). The value Y is set as a time taken for turning on the sheet sensor 203 immediately after the leading end of the sheet P is nipped in the nip portion of the second pair of rollers of the second sheet pulling and conveying apparatus 201. The value Y is determined by the conveyance speed V2 of the sheet P of the second sheet pulling and conveying apparatus 201 and a distance from the sheet sensor 203 to the nip portion of the second pair of rollers. In the embodiment, the conveyance speed V2 of the sheet P of the second sheet pulling and conveying apparatus 201 is 298.5 mm/s, and the distance from the sheet sensor 203 to the nip portion of the second pair of rollers is 45 mm, so that Y is set to 161 msec.

When the electromagnetic clutch CL2 is powered off after Y msec elapses since the sheet sensor 203 is turned on, the driving force to the first drive roller 204 is released. In other words, as illustrated in FIG. 12, since the electromagnetic clutch CL2 is in the ON state for a time from 0 to Y msec after the sheet sensor 203 is turned on, the driving force is transferred to the first drive roller 204 to convey the sheet P. Thereafter, as illustrated in FIG. 13, at the time of Y msec after the sheet sensor 203 is turned on, the leading end of the sheet P just reaches the nip portion of the second pair of rollers of the second sheet pulling and conveying apparatus 201, and the sheet P is conveyed by the driving force of the second drive roller 206. At the same time, since the electromagnetic clutch CL2 enters the OFF state and the driving force is not transferred to the first drive roller 204, the first pair of rollers of the second sheet pulling and conveying apparatus 201 are rotatably driven. In addition, since the first drive roller 204 is connected to a load portion 231 through the drive gear 204G2 and the driving transmission gear 230, a torque load is generated in order to rotate the first drive roller 204. As a result, in FIG. 13, the sheet P is conveyed between the first pair of rollers and the second pair of rollers while a tension force is generated on the sheet P. In the embodiment, the load torque of the load portion 231 is set to cause the tension force applied on the sheet P of the second sheet pulling and conveying apparatus 201 to be about 59 N (about 6 kgf).

In addition, in the embodiment, as illustrated in FIG. 6, the nip portion between the first pair of rollers and the second pair of rollers of the second sheet pulling and conveying apparatus 201 is configured to have a width (length L1) of 100 mm in the center portion in the width direction perpendicular to the sheet conveying direction. With this configuration, a tension force of about 59 N (about 6 kgf) is applied only to the center portion in the width direction from the leading end to the rear end of the sheet P.

Thereafter, the sheet P is guided to inlet guides 302 and 321 in the third sheet pulling and conveying apparatus 301, and the third sheet pulling and conveying apparatus 301 is operated similarly to the second sheet pulling and conveying apparatus 201 (S7-11 and S7-12). Further, in the embodiment, since the value Z to cause the electromagnetic clutch CL3 to be powered off is set to a value corresponding to the conveyance speed V3 (=297 mm/s) of the sheet P in the third sheet pulling and conveying apparatus 301.

Thereafter, when the sheet is completely passed, the driving motors M1, M2, and M3 are turned off (S7-13), and the process is ended (S7-14).

On the other hand, the paper type of the sheet P having a basis weight equal to or less than 90 gsm will be described (S7-6).

In a case where the tension force is applied to the sheet P having a basis weight equal to or less than 90 gsm by the sheet pulling and conveying apparatuses 201 and 301 in addition to the sheet pulling and conveying apparatus 101, the correction amount in the vicinity of the center portion of the sheet P is excessively increased. As a countermeasure, the tension is applied to the sheet P only by the sheet pulling and conveying apparatus 101, and the sheet is conveyed by the sheet pulling and conveying apparatuses 201 and 301 without applying the tension.

When the sheet P is guided to the inlet guide 121 in the first sheet pulling and conveying apparatus 101 and the ON signal of the sheet sensor 103 is confirmed (S7-15), the electromagnetic clutch CL1 is powered off after X msec (S7-16).

As described above, since the electromagnetic clutch CL1 enters the OFF state and the driving force is not transferred to the first drive roller 104, the first pair of rollers of the first sheet pulling and conveying apparatus 101 are rotatably driven. In addition, since the first drive roller 104 is connected to a load portion 131 through the drive gear 104G2 and the driving transmission gear 130, a torque load is generated in order to rotate the first drive roller 104. As a result, as illustrated in FIG. 11, the sheet P is conveyed between the first pair of rollers and the second pair of rollers while a tension force is generated on the sheet P.

Thereafter, when the sheet P is guided to the inlet guide 221 in the second sheet pulling and conveying apparatus 201 and the ON signal of the sheet sensor 203 is confirmed (S7-17), the electromagnetic clutch CL2 is powered off after Y msec (S7-18).

As described above, since the electromagnetic clutch CL2 enters the OFF state and the driving force is not transferred to the first drive roller 204, the first pair of rollers of the second sheet pulling and conveying apparatus 201 are rotatably driven. In addition, since the first drive roller 204 is connected to a load portion 231 through the drive gear 204G2 and the driving transmission gear 230, a torque load is generated in order to rotate the first drive roller 204. As a result, as illustrated in FIG. 13, the sheet P is conveyed between the first pair of rollers and the second pair of rollers while a tension force is generated on the sheet P.

Thereafter, the sheet P discharged from the second sheet pulling and conveying apparatus 201 is conveyed to the third sheet pulling and conveying apparatus 301. In the third sheet pulling and conveying apparatus 301, the electromagnetic clutch CL3 is left in the ON state, and the driving force is transferred to the first pair of rollers, so that the load torque is not applied to the first pair of rollers. Therefore, the sheet P is conveyed without being applied with the tension force, and discharged from the third sheet pulling and conveying apparatus 301.

Thereafter, when the sheet is completely passed, the driving motors M1, M2, and M3 are turned off (S7-13), and the process is ended (S7-14).

Further, the same flow of passing the sheet is repeated for the second sheet and subsequent sheets.

To sum up, the flow is as follows. In a case where the controller 901C acquires information that the basis weight of the sheet is less than 90 gsm (the first basis weight), the controller 901C makes control on the third sheet pulling and conveying apparatus 301 such that no tensile stress is generated on the sheet P. In other words, the control is performed to transfer the driving force of the first drive roller 304 such that no tensile stress is generated on the sheet P nipped between the first drive roller 304 and the first pressure roller 305 and between the second drive roller 306 and the second pressure roller 307. On the other hand, in a case where the controller 901C acquires information that the basis weight of the sheet is equal to or more than 90 gsm (the second basis weight), the controller 901C makes control on the third sheet pulling and conveying apparatus 301 such that the tensile stress is generated on the sheet P. In other words, the control is performed not to transfer the driving force of the first drive roller 304 such that the tensile stress is generated on the sheet P nipped between the first drive roller 304 and the first pressure roller 305 and between the second drive roller 306 and the second pressure roller 307.

### <Examination Result of Present Embodiment>

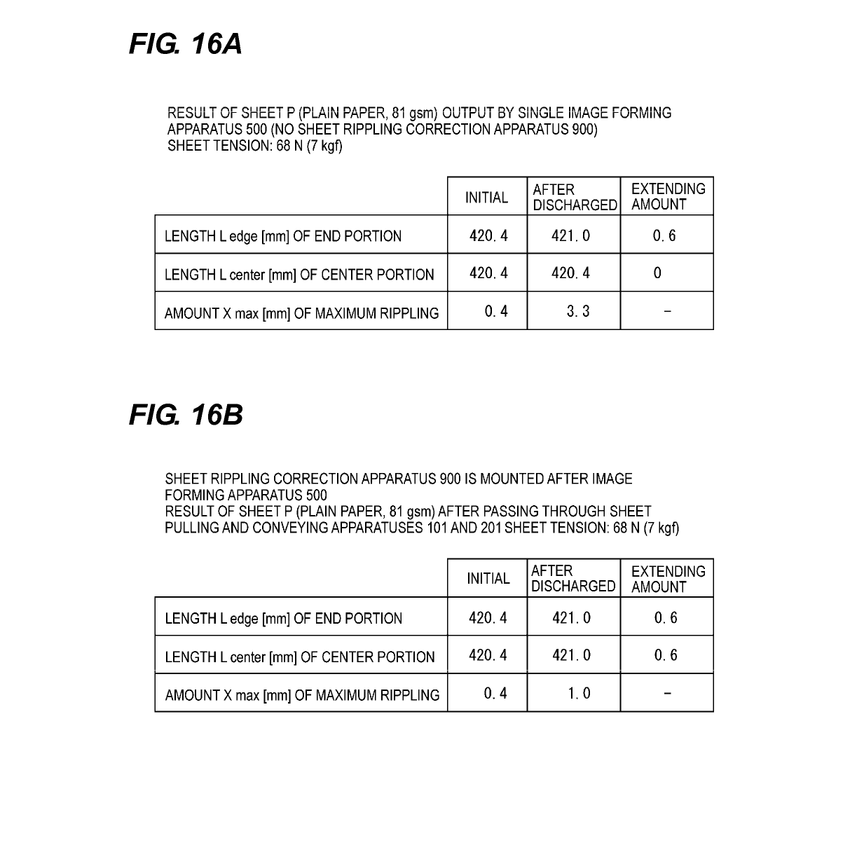

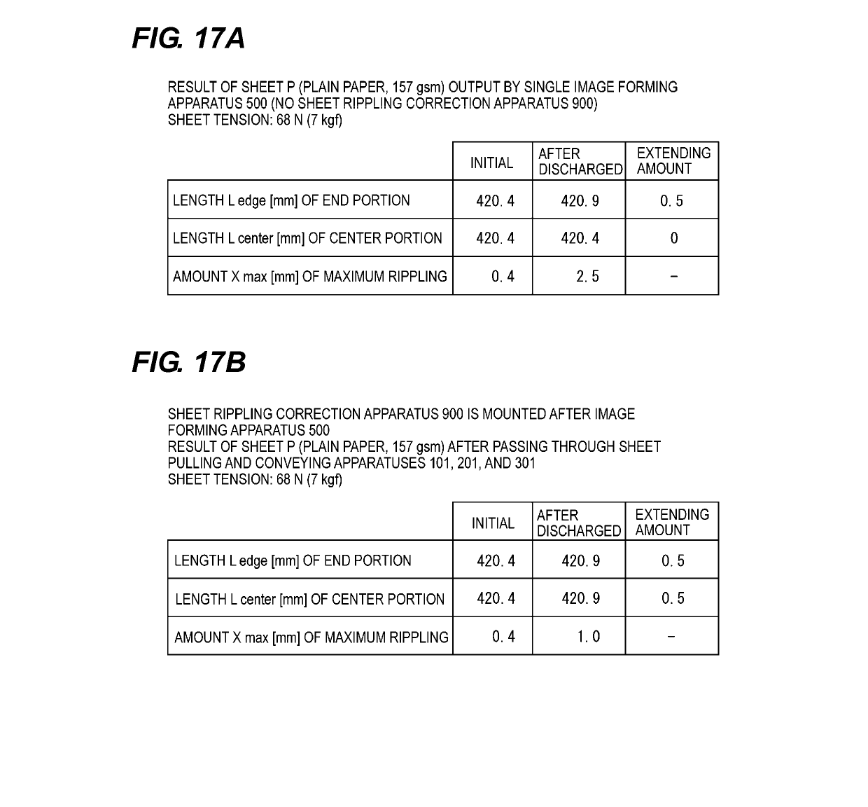

FIGS. 16A, 16B, and 17 show the results of experiment on the sheets P having basis weights of 81 gsm and 157 gsm to confirm the effects of the sheet pulling and conveying apparatuses 101, 201, and 301.

FIG. 16A shows the measurement results of the length L edge [mm] of the end portion and the length L center [mm] of the center portion of the sheet P which has passed through the first sheet pulling and conveying apparatus 101 of the embodiment immediately after passing through the fixing apparatus 100. In addition, a maximum rippling amount X max [mm] of the sheet P was measured. FIG. 16B shows the measurement results of the length L edge [mm] of the end portion and the length L center [mm] of the center portion of the sheet P which has been applied with the tension only by the sheet pulling and conveying apparatuses 101 and 201 of the embodiment after passing through the fixing apparatus 100. In addition, the maximum rippling amount X max [mm] of the sheet P was measured.

First, the results of experiment on the sheet P (the plain paper) having a basis weight of 81 gsm to confirm the effects of the sheet pulling and conveying apparatuses 101, 201, and 301 will be described using FIGS. 16A and 16B.

As illustrated in FIG. 16A, immediately after the sheet P passes through the fixing apparatus, an extension amount of the length L center of the center portion is 0 mm, and the extension amount of the length L edge of the end portion is 0.6 mm; that is, the end portion is extended further more by 0.6 mm. This is because in a case where the fixing apparatus is provided with the wide nip portion, the end portion in the width direction of the sheet discharged from the nip portion is extended in the conveyance direction further more compared to the center portion. In a case where the fixing apparatus is provided with the wide nip portion, the wrinkles of the sheet is prevented in process of passing through the nip portion, so that the conveyance speed on the end portion is set to be higher than that on the center portion in the width direction of the sheet in the nip portion in order to apply the pulling action. With this configuration, in a case where the fixing apparatus is provided with the wide nip portion, the end portion in the width direction of the sheet discharged from the nip portion is extended in the conveyance direction further more compared to the center portion.

On the other hand, as illustrated in FIG. 16B, after passing through the fixing apparatus (the sheet passes at 300 mm/s), the sheet passes in an order of the first sheet pulling and conveying apparatus 101 (the sheet passes at 300 mm/s) and the second sheet pulling and conveying apparatus 201 (the sheet passes at 298.5 mm/s) of the embodiment. In this case, the extension amount of the length L center immediately after the sheet passes through the third sheet pulling and conveying apparatus 301 is 0.6 mm. In this regard, the extension amount of the length L edge of the end portion is 0.6 mm, and a difference in length between the end portion and the center portion becomes 0 mm. In other words, by passing through the first sheet pulling and conveying apparatus 101 and the second sheet pulling and conveying apparatus 201, the sheet is extended in the conveyance direction, and as a result a difference between the end portion and the center portion is reduced. As a result, since the difference in length between the end portion and the center portion of the sheet is reduced, the maximum rippling amount is improved from 3.3 mm as illustrated in FIG. 16A to 1.0 mm as illustrated in FIG. 16B.

Next, the results of experiment on the sheet P (the plain paper) having a basis weight of 157 gsm to confirm the effects of the sheet pulling and conveying apparatuses 101, 201, and 301 will be described using FIGS. 17A and 17B.

As illustrated in FIG. 17A, immediately after the sheet P passes through the fixing apparatus, an extension amount of the length L center of the center portion is 0 mm, and the extension amount of the length L edge of the end portion is 0.5 mm; that is, the end portion is extended further more by 0.5 mm

On the other hand, as illustrated in FIG. 17B, after passing through the fixing apparatus, the sheet passes in an order of the first sheet pulling and conveying apparatus 101, the second sheet pulling and conveying apparatus 201, and the third sheet pulling and conveying apparatus 301 of the embodiment. Herein, the sheet passes through the fixing apparatus at 300 mm/s. In this embodiment, the sheet passes through the first sheet pulling and conveying apparatus 101 at 300 mm/s, the second sheet pulling and conveying apparatus 201 at 298.5 mm/s, and the third sheet pulling and conveying apparatus 301 at 297.0 mm/s. In this case, the extension amount of the length L center of the center portion immediately after the sheet passes through the third sheet pulling and conveying apparatus 301 is 0.5 mm. In this regard, the extension amount of the length L edge of the end portion is 0.5 mm, and a difference in length between the end portion and the center portion becomes 0 mm. In other words, by passing through the first sheet pulling and conveying apparatus 101, the second sheet pulling and conveying apparatus 201, and the third sheet pulling and conveying apparatus 301, the sheet is extended in the conveyance direction, and as a result a difference between the end portion and the center portion is reduced. As a result, since the difference in length between the end portion and the center portion of the sheet is reduced, the maximum rippling amount is improved from 5 mm as illustrated in FIG. 17A to 1 mm as illustrated in FIG. 17B.

As described above, the sufficient pulling effect on the sheet P is achieved by conveying the sheet P to the plurality of sheet pulling and conveying apparatuses such as the first sheet pulling and conveying apparatus 101, the second sheet pulling and conveying apparatus 201, and the third sheet pulling and conveying apparatus 301. Therefore, the difference in length between the end portion and the center portion is reduced, and the rippling can be improved.

### <Effects of Present Embodiment>

As described above, according to the embodiment, since the plurality of sheet pulling and conveying apparatuses are provided, the tension can be applied on the sheet in a stepped manner by controlling the number of pulling cycles without applying a steep tension on the sheet at once. Further, it is possible to switch the operations of the plurality of sheet extending apparatuses according to the paper type of the sheet P.

With this configuration, it is possible to suppress the damage caused by applying the steep tension on the sheet P. Further, according to the paper type information on the sheet, it is possible to control the number of pulling cycles in the vicinity of the center portion of the sheet P, and the amount to correct the difference in length with respect to the vicinity of the end portion. As a result, the rippling of the sheet P can be improved according to the paper type while suppressing the stress on the sheet P at a minimum level.

### Second Embodiment

Next, an image forming apparatus which includes a sheet conveying apparatus according to a second embodiment will be described. While the above-mentioned the first embodiment is configured such that the plurality of sheet pulling and conveying apparatuses are disposed in the lengthwise direction (gravitational direction, vertical direction), the second embodiment is configured such that the plurality of sheet pulling and conveying apparatuses are disposed in the horizontal direction (a direction intersecting with the vertical direction). In addition, the embodiment will be described about an image forming system in which the sheet conveying apparatus is integrally assembled in the image forming apparatus. However, as described in the above embodiment, the invention is also effectively applied even to the image forming system in which the sheet conveying apparatus is connected to the outside of the image forming apparatus. In the description of the second embodiment below, the descriptions of the configurations and the operations in common with the first embodiment will not be repeated in moderation.

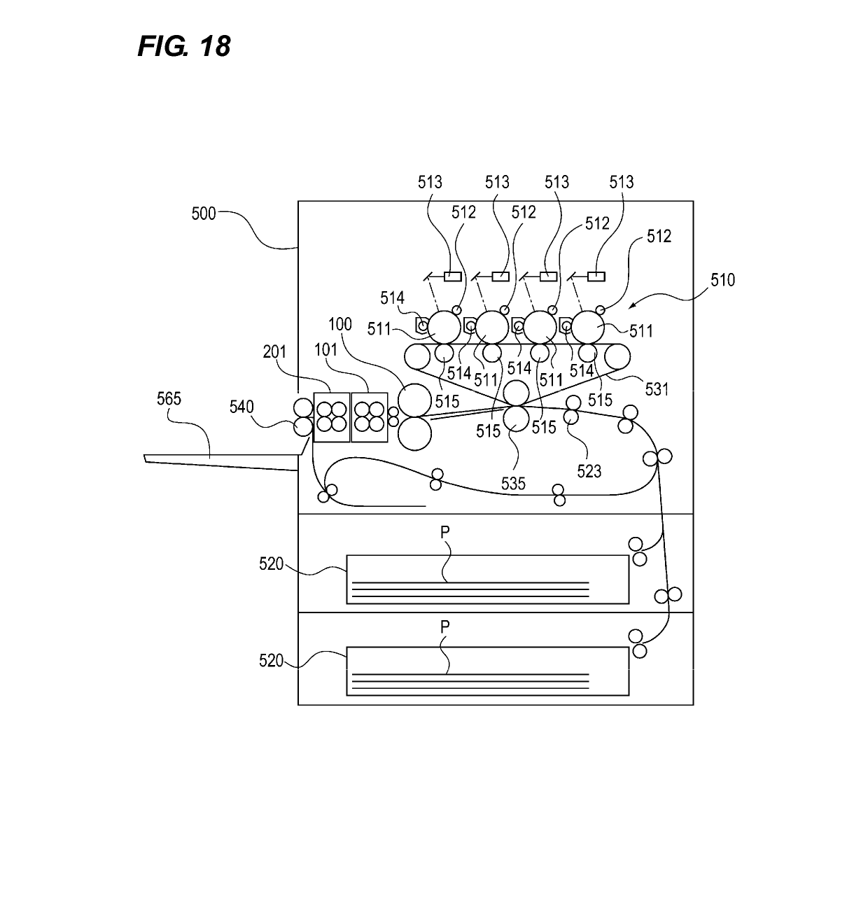

FIG. 18 is a cross-sectional view schematically illustrating the image forming apparatus in which the sheet conveying apparatus according to the second embodiment is integrally assembled. Since the configuration of the image forming apparatus according to the embodiment is almost the same as that described using FIG. 2 in the first embodiment, the same members having the same functions will be denoted with the same symbols, and the detailed descriptions thereof will not be repeated.

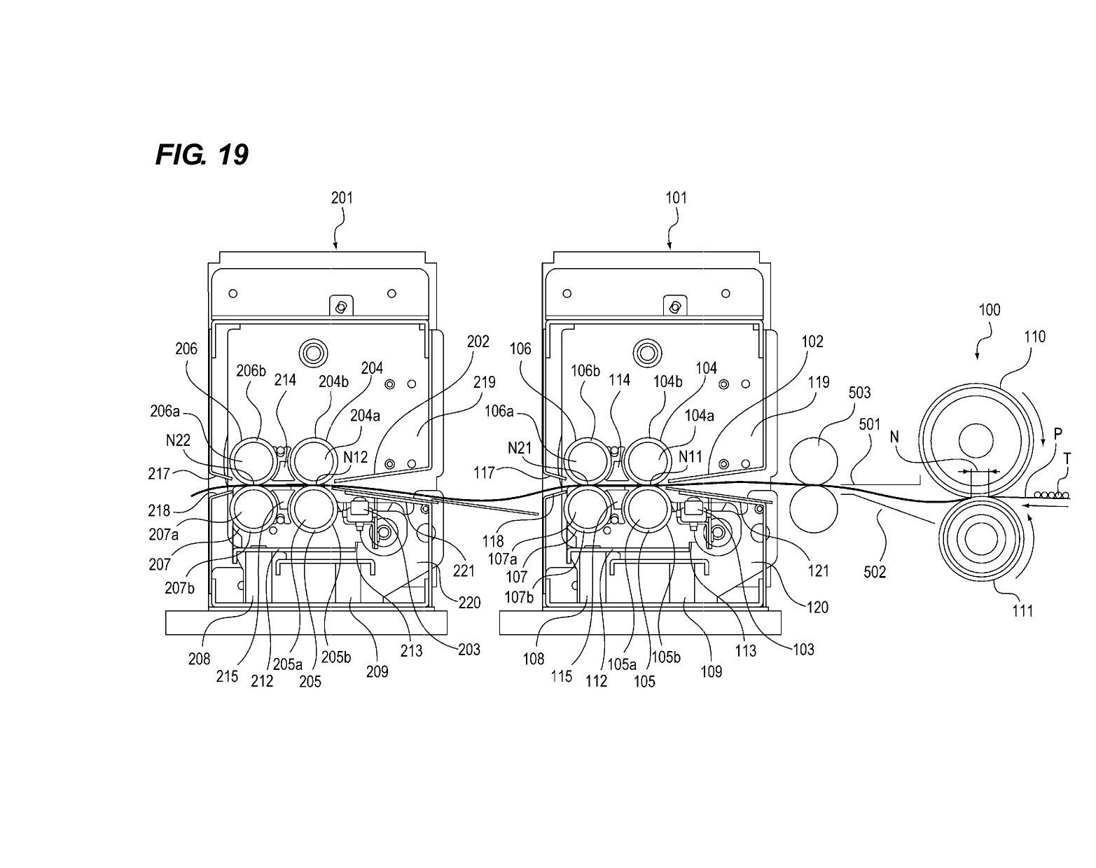

Hereinafter, the sheet conveying apparatus integrally assembled in the image forming apparatus illustrated in FIG. 18 will be described using FIG. 19. In the embodiment, the sheet conveying apparatus includes two sheet pulling and conveying apparatuses as a plurality of tension applying apparatuses, and two sheet pulling and conveying apparatuses are disposed on the downstream side in the conveyance direction of the fixing apparatus 100. Since the sheet pulling and conveying apparatuses 101 and 201 are configured to apply the tension to the sheet P by two pairs of rollers similarly to the first embodiment, the description thereof will not be repeated.

Even in this embodiment, since the plurality of sheet pulling and conveying apparatuses are provided similarly to the above-mentioned embodiment, the tension can be applied on the sheet in a stepped manner by controlling the number of pulling cycles without applying a steep tension on the sheet at once. Further, it is possible to switch the operations of the plurality of sheet extending apparatuses according to the paper type of the sheet P.

With this configuration, it is possible to suppress the damage caused by applying the steep tension on the sheet P. Further, according to the paper type information on the sheet, it is possible to control the number of pulling cycles in the vicinity of the center portion of the sheet P, and the amount to correct the difference in length with respect to the vicinity of the end portion. As a result, the rippling of the sheet P can be improved according to the paper type while suppressing the stress on the sheet P at a minimum level.

### Third Embodiment

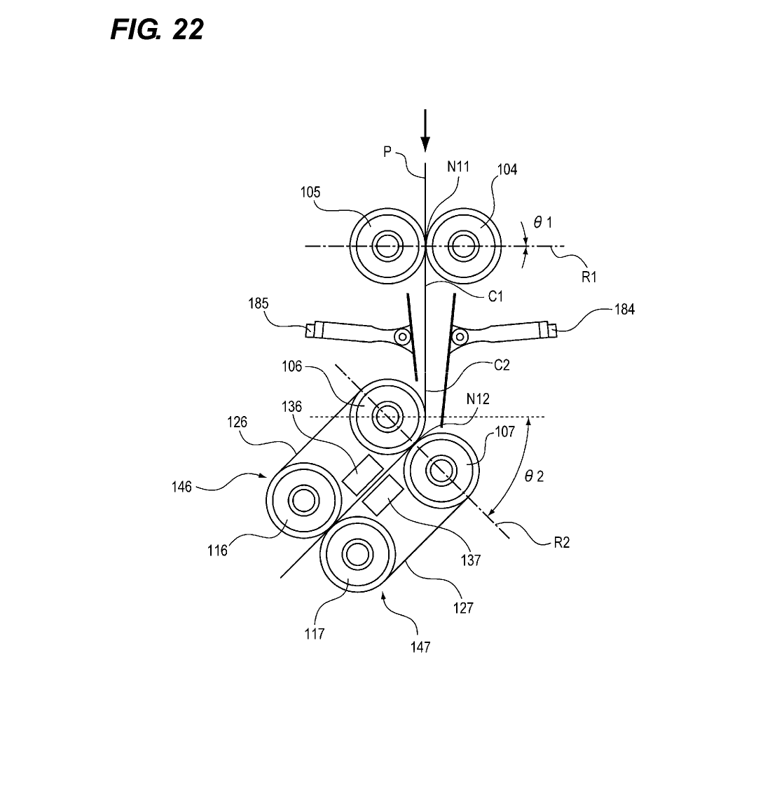

A third embodiment will be described using FIG. 22. This embodiment employs the same configuration as that in the first embodiment except that only the pulling and conveying apparatus in the sheet processing apparatus is changed. Therefore, the descriptions other than the pulling and conveying apparatus will not be repeated.

A difference from the first embodiment is that the pair of rotators on the downstream side in the conveyance direction of the sheet P are formed by a pair of belts. As illustrated in FIG. 22, the sheet P is wrapped and pulled by a second driving belt 146 so as to be extended.

The pair of belts include the second driving belt 146 and a second pressure belt 147. The second driving belt 146 includes a second driving endless belt 126, the second drive roller 106, a second driving endless belt roller 116, and a second driving-side pressure pad 136. The second pressure belt 147 includes a second pressure endless belt 127, the second pressure roller 107, a second pressure-side endless belt roller 117, and a second pressure-side pressure pad 137.

The second drive roller 106 and the second pressure roller 107 include the elastic rubber in the center portion in the width direction. Therefore, at a position where the second drive roller 106 and the second pressure roller 107 face each other, a nip portion is formed in the center portion in the width direction between the second driving belt 146 and the second pressure belt 147. In other words, a strong contact pressure between the second driving belt 146 and the second pressure belt 147 appears in the center portion in the width direction compared to the end portion in the width direction.

Otherwise, a pair of rollers such as the first drive roller 104 and the first pressure roller 105 serving as the pair of rotators on the upstream side correspond to the configuration of the first embodiment, and the detailed descriptions will not be repeated.

When the sheet P is conveyed to the pulling and conveying apparatus illustrated in FIG. 22, the sheet P passes through the first nip portion N11 formed between the first drive roller 104 and the first pressure roller 105. Thereafter, the sheet P is guided to sheet guides 184 and 185, and passes through the second nip portion N21 formed between the second driving belt 146 and the second pressure belt 147. When the sheet P simultaneously passes through the first nip portion N11 and the second nip portion N21, the tension force is applied on the sheet P. When the tension force is applied on the sheet P, the sheet P forms a conveyance path C1 on the downstream side from the first nip portion N11. In addition, the sheet P forms a conveyance path C2 on the upstream side from the second nip portion N21. In FIG. 22, the conveyance path C1 and the conveyance path C2 are in the same straight line. In the conveyance path C2, the sheet P is wrapped around the second driving belt 146 at a second wrapping angle θ2.

At this time, since the sheet P is wrapped around the second driving belt 146 at the second wrapping angle θ2, the sheet P is applied with a bending stress at the same time as the tensile stress. In this way, since the sheet P is applied with the bending stress and pulled, the sheet can be efficiently pulled compared to the case where the sheet is simply pulled in a straight line. Since the tensile stress and the bending stress are applied on the sheet P in excess of the proof strength of the sheet, the sheet P is plastically extended.

Further, a magnitude relation between θ1 and θ2 is not limited to the embodiment. For example, the magnitude relation may be θ1>θ2, θ1<θ2, or θ1≈θ2.

FIG. 22 illustrates a configuration of bending and extending the sheet P. A straight line connecting a rotation center of the first drive roller 104 and a rotation center of the first pressure roller 105 is referred to as a roller center line R1. Subsequently, a straight line connecting a rotation center of the second drive roller 106 and a rotation center of the second pressure roller 107 is referred to as a roller center line R2.

The second pair of belts 146 and 147 are configured to be inclined with respect to the pair of rollers 104 and 105 vertically disposed with respect to the conveyance path C2. In other words, the center line R2 is inclined with respect to the center line R1, and thus not in parallel with each other.

Since the center line R1 and the center line R2 are configured not in parallel, the sheet P can be wrapped by a first pair of rollers (the first pair of rotators) among the plurality of pairs of rotators, or at least one of a second pair of belts (the second pair of rotators).

Further, in a case where a first pair of rotators are a pair of belts, among the rollers suspending the belts, a line connecting the rotation centers of the pair of rollers on the downstream side in the sheet conveying direction is referred to as the center line R1. On the other hand, in a case where a second pair of rotators are a pair of belts, among the rollers suspending the belts, a line connecting the rotation centers of the pair of rollers on the upstream side in the sheet conveying direction is referred to as the center line R2.

In FIG. 22, in a case where the tension is applied on the sheet P while wrapping the sheet P around the second driving belt 146, the pressing force between the nip portions of the pairs of rollers is necessarily increased to some degrees as described in the first embodiment.

In the embodiment, the second drive roller 106 suspending the second driving belt 146 is configured as a fixed roller which is fixed to a side plate and only rotatable. With this configuration, the pressing force between the nip portions of the pairs of belts is not reduced.

In this way, even in a case where the pair of belts are used as the pair of rotators instead of the pair of rollers, the same effect as the first embodiment can be obtained. In addition, in the configurations of the first and second embodiments, even in a case where the pair of rollers are replaced with the pair of belts, the same effect can be obtained.

Further, in the third embodiment, the second pair of rotators on the downstream side in the conveyance direction of the sheet P are configured as the pair of belts, but the invention is not limited thereto. The pair of rotators on the upstream side in the conveyance direction of the sheet P may be configured by the pair of belts.

As described above, even in the third embodiment, it is possible to obtain the effect that the sheet P is efficiently extended similarly to the first and second embodiments.

In addition, the conveyance force can be improved by replacing the pair of rollers in the first and second embodiments with the pair of belts.

### OTHER EMBODIMENTS

### Crown of Pulling Roller

Further, in the embodiment described above, the widths of the elastic rubbers 105b and 107b of the first pressure roller 105 and the second pressure roller 107 of the first sheet pulling and conveying apparatus 101 are set to 100 mm, but the invention is not limited thereto. An external diameter of at least one pair of rollers in the first pair of rollers and the second pair of rollers which form the sheet pulling and conveying apparatus may be larger in the center portion in the direction of the rotation shaft compared to the end portion in the direction of the rotation shaft.

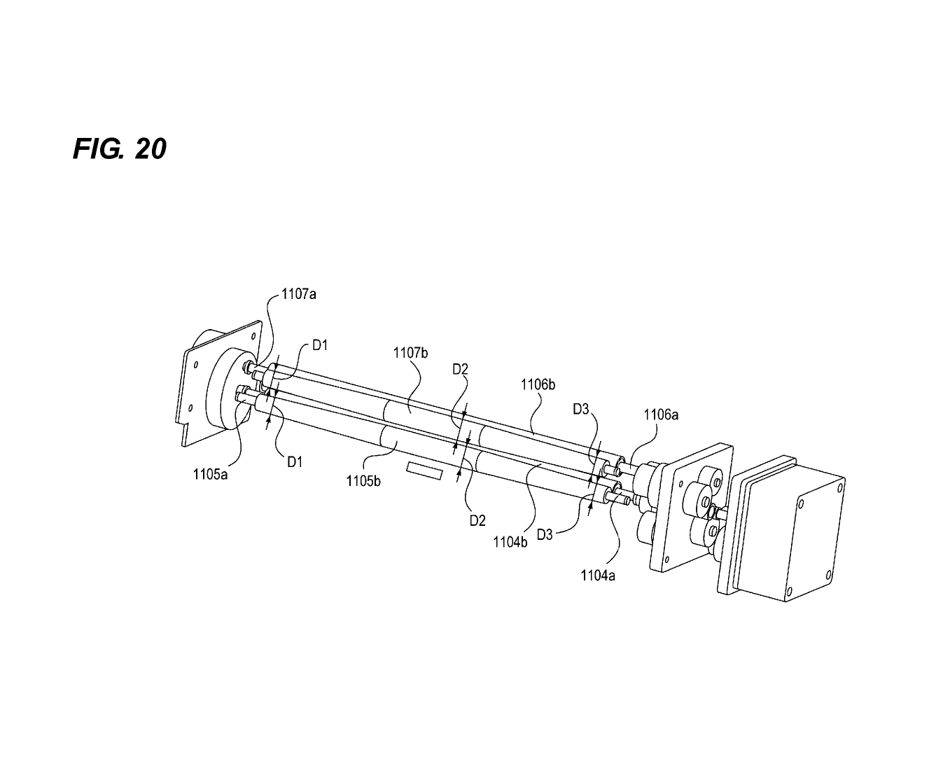

Specifically, for example, as illustrated in FIG. 20, the lengths in the width direction of elastic rubbers 1105b and 1107b of a first pressure roller 1105 and a second pressure roller 1107 may be longer than that in the width direction of a maximum sheet. In addition, the external diameters in the vicinity of the center portions of the elastic rubbers 1105b and 1107b of the first pressure roller 1105 and the second pressure roller 1107 are set to D2, and external diameters of both end portions may be set to D1 and D3 smaller than D2 (D2>D1, D3). In FIG. 20, D2 is set to 25 mm, and D1 and D3 are set to 24.7 mm. The width of D2 is maintained in a straight shape only over a range of 100 mm in the center portion, and then the external diameter is reduced in a taper shape as it goes to the end portions therefrom.

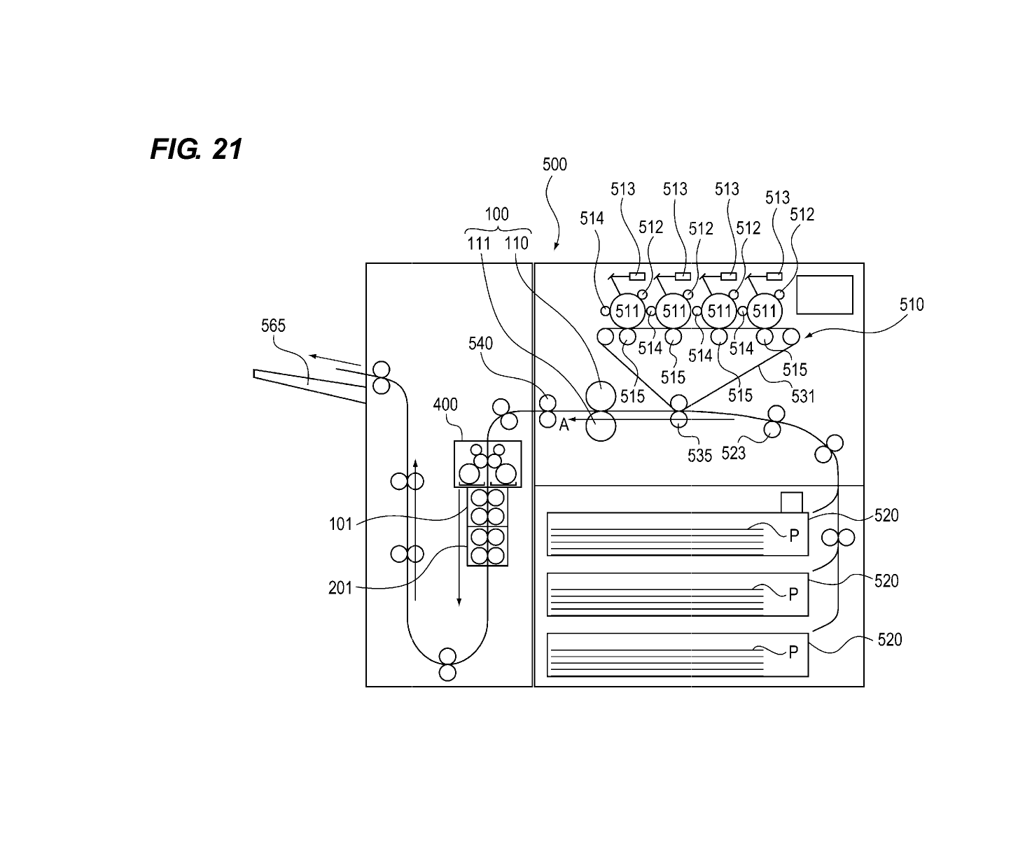

With this configuration, since the conveyance speed (the rotation speed of the roller) of the sheet P is faster in the center portion in the width direction than the end portion, and the nip pressure in the center portion is increased, the tension force is applied to the center portion of the sheet. Therefore, similarly to the above embodiment, the difference in length between the end portion and the center portion is reduced, and the rippling can be improved. In addition, the external diameter shape is formed in the taper shape in FIG. 20, but the external diameter shape may be formed in a crown shape which is formed in a parabola shape. In addition, the configuration of the roller in FIG. 21 may be applied to the second sheet pulling and conveying apparatus 201.

In the first embodiment, three sheet pulling and conveying apparatuses (101, 201, and 301) connected to pass the sheet are exemplified as the plurality of conveyance units of the sheet conveying apparatus, but the invention is not limited thereto. The number of conveyance units may be two, or may be four or more.

In addition, one sheet pulling and conveying apparatus may be provided to determine whether the sheet P is extended or not based on the information on the sheet. There may be considered a case where some sheets are originally not necessary for the improvement against the rippling depending on the type of the sheet P. In a case where the sheet P is not necessary for the improvement against the rippling, the sheet P is not extended in order not to apply a stress on the sheet.

In addition, tension setting values of the torque applying apparatuses 131, 231, and 331 of the respective sheet pulling and conveying apparatuses are equally set as a pulling condition on the sheet P, but the setting values may be individually set in the respective sheet pulling and conveying apparatuses.

In addition, the basis weight of the sheet P as the paper type information of the sheet P has been used for a switching condition between the plurality of sheet pulling and conveying apparatuses. However, as information on the sheet, the paper type (the plain paper, the presence of a coat layer) of the sheet P, image information, a moisture amount of the sheet may be used.

In the first embodiment, the sheet conveying apparatus which is an external apparatus optionally and detachably attached to the image forming apparatus has been configured such that the plurality of sheet pulling and conveying apparatuses are connected, but the invention is not limited thereto. The sheet pulling and conveying apparatus may be integrally assembled in the image forming apparatus.

In the first embodiment, the description has been made about the configuration in which the sheet pulling and conveying apparatus includes the controller 901C and the operation thereof is controlled by the controller 901C, but the invention is not limited thereto. For example, the sheet rippling correction apparatus does not include the controller, and the operation of the sheet rippling correction apparatus may be controlled by the controller 500C of the printer. The operation of the sheet pulling and conveying apparatus may be controlled such that the controller 901C of the sheet pulling and conveying apparatus is controlled by the controller 500C of the image forming apparatus. The same effects can also be achieved even in these configurations.

In the first embodiment, the driving force to the first drive roller 104 has been turned on/off using the clutch mechanism as a mechanism for applying the tension on the sheet, but the invention is not limited thereto. While not illustrated in the embodiment, there may be provided a drive source to drive the first drive roller 104 and the second drive roller 106, so that the driving force to the first drive roller 104 and the second drive roller 106 may be turned on/off by turning on/off the drive source itself.

In addition, in the above-mentioned embodiment, the printer has been exemplified as the image forming apparatus, but the invention is not limited thereto. For example, another image forming apparatus such as a copying machine and a facsimile apparatus or other image forming apparatuses such as a multifunctional peripheral in which these functions are combined may be employed. In addition, the invention may be applied to an ink-jet printer which ejects ink to form an image in the sheet.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-029213, filed Feb. 19, 2014, No. 2014-093703, filed Apr. 30, 2014, and No. 2014-263790, filed Dec. 26, 2014, which are hereby incorporated by reference herein in their entirety.

What is claimed is:

1. A sheet conveying apparatus comprising:
a conveyance unit configured to include
a first pair of rotators which convey a sheet,
a second pair of rotators which are provided on a downstream side of the first pair of rotators in a sheet conveying direction and convey the sheet, and
a load portion which applies a load on the rotation of the first pair of rotators to generate a tensile stress on the sheet when the sheet is nipped between the first pair of rotators and the second pair of rotators; and
a controller configured to control whether to apply a load on the first pair of rotators by the load portion based on information on the conveyed sheet.

2. The sheet conveying apparatus according to claim 1,
wherein at least two conveyance units are arranged in the sheet conveying direction, and
wherein the controller controls whether to apply a load on the first pair of rotators which are provided in at least one conveyance unit.

3. The sheet conveying apparatus according to claim 1,
wherein the controller sets the first pair of rotators to a no-load state when information indicating that a basis weight of the conveyed sheet is a first basis weight is acquired, and sets the first pair of rotators to a load state when the information indicating that the basis weight of the conveyed sheet is a second basis weight larger than the first basis weight is acquired.

4. The sheet conveying apparatus according to claim 1, further comprising:
an acquisition portion configured to acquire information on the conveyed sheet,
wherein the control is performed according to the information on the sheet acquired by the acquisition portion.

5. The sheet conveying apparatus according to claim 1,
wherein at least one of the first pair of rotators and the second pair of rotators is a pair of rollers, and an external diameter of the pair of rollers is larger in the center portion in a direction of a rotation shaft compared to the end portion in the direction of the rotation shaft.

6. The sheet conveying apparatus according to claim 1,
wherein a nip portion formed by the first pair of rotators is a first nip portion and a nip portion formed by the second pair of rotators is a second nip portion, and
wherein at least one of the first nip portion and the second nip portion is in an area in the center portion of the conveyed sheet in a width direction perpendicular to the sheet conveying direction.

7. The sheet conveying apparatus according to claim 1,
wherein a nip portion formed by the first pair of rotators is a first nip portion and a nip portion formed by the second pair of rotators is a second nip portion, and
wherein a length of at least one of the first nip portion and the second nip portion in the width direction perpendicular to the sheet conveying direction is shorter than a length of the conveyed sheet.

8. The sheet conveying apparatus according to claim 1, further comprising:
a humidification portion configured to apply moisture to the sheet,
wherein the humidification portion is disposed on an upstream side in the sheet conveying direction of the conveyance unit.

9. A sheet conveying apparatus comprising:
a conveyance unit configured to include
a first pair of rotators which convey a sheet,
a second pair of rotators which are provided on a downstream side in a sheet conveying direction of the first pair of rotators and convey the sheet, and
a load portion which applies a load on the rotation of the first pair of rotators when the first pair of rotators rotate in a state where a driving is not transferred to the first pair of rotators;
a drive portion configured to apply a driving to at least one rotator of the first pair of rotators; and
a controller configured to control whether to apply a driving from the drive portion to the first pair of rotators based on information on the conveyed sheet when the sheet is nipped between the first pair of rotators and the second pair of rotators.

10. The sheet conveying apparatus according to claim 9,
wherein at least two conveyance units are arranged in the sheet conveying direction, and
wherein the controller controls whether to apply a driving from the drive portion to the first pair of rotators which are provided in each conveyance unit.

11. The sheet conveying apparatus according to claim 9,
wherein the controller sets the first pair of rotators to a driving state when information indicating that a basis weight of the conveyed sheet is a first basis weight is acquired, and sets the first pair of rotators to a no-driving state when the information indicating that the basis weight of the conveyed sheet is a second basis weight larger than the first basis weight is acquired.

12. The sheet conveying apparatus according to claim 9, further comprising:
an acquisition portion configured to acquire information on the conveyed sheet,
wherein the control is performed according to the information on the sheet acquired by the acquisition portion.

13. The sheet conveying apparatus according to claim 9,
wherein at least one of the first pair of rotators and the second pair of rotators is a pair of rollers, and an external diameter of the pair of rollers is larger in the center portion in a direction of a rotation shaft compared to the end portion in the direction of the rotation shaft.

14. The sheet conveying apparatus according to claim 9,
wherein a nip portion formed by the first pair of rotators is a first nip portion and a nip portion formed by the second pair of rotators is a second nip portion, and
wherein at least one of the first nip portion and the second nip portion is in an area in the center portion of the conveyed sheet in a width direction perpendicular to the sheet conveying direction.

15. The sheet conveying apparatus according to claim 9,
wherein a nip portion formed by the first pair of rotators is a first nip portion and a nip portion formed by the second pair of rotators is a second nip portion, and
wherein a length of at least one of the first nip portion and the second nip portion in the width direction perpendicular to the sheet conveying direction is shorter than a length of the conveyed sheet.

16. The sheet conveying apparatus according to claim 9, further comprising:
a humidification portion configured to apply moisture to the sheet,
wherein the humidification portion is disposed on an upstream side in the sheet conveying direction of the conveyance unit.

17. An image forming apparatus comprising:
an image forming portion configured to form a toner image in a sheet;
a fixing portion configured to fix the toner image on the sheet formed by the image forming portion onto the sheet by heating; and
a sheet conveying apparatus configured to convey the sheet which passes through the fixing portion,
wherein the sheet conveying apparatus includes
a conveyance unit configured to include
a first pair of rotators which convey a sheet,
a second pair of rotators which are provided on a downstream side of the first pair of rotators in a sheet conveying direction and convey the sheet, and
a load portion which applies a load on the rotation of the first pair of rotators to generate a tensile stress on the sheet when the sheet is nipped between the first pair of rotators and the second pair of rotators, and
a controller configured to control whether to apply a load on the first pair of rotators by the load portion based on information on the conveyed sheet.

18. The image forming apparatus according to claim 17,
wherein at least two conveyance units are arranged in the sheet conveying direction, and
wherein the controller controls whether to apply a load on the first pair of rotators which are provided in at least one conveyance unit.

19. The image forming apparatus according to claim 17,
wherein the controller sets the first pair of rotators to a no-load state when information indicating that a basis weight of the conveyed sheet is a first basis weight is acquired, and sets the first pair of rotators to a load state when the information indicating that the basis weight of the conveyed sheet is a second basis weight larger than the first basis weight is acquired.

20. A sheet conveying apparatus comprising:
a conveyance unit configured to include
a first pair of rotators which convey a sheet,
a second pair of rotators which are provided on a downstream side in a sheet conveying direction of the first pair of rotators and convey the sheet, and
a load portion which applies a load on the rotation of the first pair of rotators when the first pair of rotators rotate in a state where a driving is not transferred to the first pair of rotators;
a drive portion configured to apply a driving to at least one rotator of the first pair of rotators; and
a controller configured to control whether to apply a driving from the drive portion to the first pair of rotators based on information on the conveyed sheet when the sheet is nipped between the first pair of rotators and the second pair of rotators.

21. The sheet conveying apparatus according to claim 20,
wherein at least two conveyance units are arranged in the sheet conveying direction, and
wherein the controller controls whether to apply a driving from the drive portion to the first pair of rotators which are provided in each conveyance unit.

22. The sheet conveying apparatus according to claim 20,
wherein the controller sets the first pair of rotators to a driving state when information indicating that a basis weight of the conveyed sheet is a first basis weight is acquired, and sets the first pair of rotators to a no-driving state when the information indicating that the basis weight of the conveyed sheet is a second basis weight larger than the first basis weight is acquired.
